(19) United States
(12) Patent Application Publication
(10) Pub. No.: US 2002/0083145 A1
(43) Pub. Date: Jun. 27, 2002

(54) Method and system for online/offline services

(75) Inventor: Nishanthan M.T. Perinpanathan, Montreal (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/742,121

(22) Filed: Dec. 22, 2000

(51) Int. Cl. G06F 15/16; G06F 15/167

(52) U.S. Cl. 709/213; 709/219

(57) ABSTRACT

Embodiments of the invention provide a device which may, during online communications, retrieve content and an online/offline agent tailored to the retrieved content, interactive application and the device being used. Once retrieved the content is stored in memory and the online/offline agent commences execution. The device may go offline while a user interacts with the content and the online/offline agent tracks and stores the user's interactions. At any point the device may go back online (as a result of, for example, a user's selection or instructions) and communicate with a synchronization server a device adapted to receive and interpret tracked data. Once in communication, the device uploads tracked data and, in some instances, receives additional instructions or content responsive to the tracked data uploaded. Additionally, and in some embodiments of the present invention, the device is enabled to communicate with other similar devices. During communication with these other devices, a device embodying the present invention may transfer an online/offline agent, content or tracked data. This inter-device communication may occur indirectly using conventional networks (e.g., a digital wireless network, wireline network or a combination thereto) or directly (e.g., using radio or infrared communication). Resulting from this peer-to-peer communication, users (i.e., human or machine users) of devices embodying aspects of the invention, may communicate and collaborate while offline from conventional networks.

### FIELD OF THE INVENTION

The present invention relates to a method, system, and apparatus for providing online/offline services and more particularly to online/offline content interaction and user collaboration.

### BACKGROUND OF THE INVENTION

Recently, wireless networking has started to become more popular. Initially considered an item only for the rich and famous, wireless telephones are now quite commonplace. Additionally, much of the wireless infrastructure was initially designed and/or used for analog voice communications. However, with the recent conversion to digital systems (which has increased bandwidth, reliability and affordability), the wireless infrastructure is presently being used to transfer voice and data. Moreover, it is expected that use of wireless networks for data transmission will continue to increase dramatically.

However, due to the inherent difficulties in obtaining a wireless signal in many areas (e.g., due to connection instability and unpredictable network availability), wireless communications (and specifically wireless networking) tends to be transient and non-persistent (unlike conventional networks which now tend to be “up” or active at all times). As a result of this transient nature, users of wireless networks often encounter difficulties in obtaining and interacting with the content required or desired. For example, a purchaser for a large retail department store may, while travelling, wish to interact with a supplier's catalog using a wireless connection so that an order can be placed for the upcoming season. However, due to restricted availability of a wireless “connection” when travelling in an airplane, through tunnels, etc., present systems do not enable an interactive environment which is easy to use, productive and efficient and which accounts for the transient nature of wireless connections.

Additionally, due to the nature of wireless networks, environmental changes (e.g., electrical storms, snow storms, change in demand for services by other users, etc.) often significantly affect the effective bandwidth available during a wireless connection. As a result and with present systems, a wireless internet user may satisfactorily commence wireless interaction with a bandwidth intensive web site during near ideal environmental conditions. However, this same wireless interaction may become frustratingly unusable during less than ideal conditions.

Other applications using the semi-centralized client-server architecture also create difficulties for those users accessing services using wireless connections. For example, in many situations, a single supplier will have a team of customer support representatives deployed at a customer's site. These customer support representatives may wish to interact with different people each identifying different problems at the customer's site which may be recorded in a handheld computing device (e.g., a Palm™ computer or the like). However, a collated record of each representative's interaction with the data may only be created once each representative connects with the (distant) head office server. As a result, the representatives are unable to collaborate (e.g., work/comment/append/amend each other's data) in a timely fashion. This delayed interaction and collaboration is often frustrating to users and may impact productivity.

Accordingly, it is desirable to provide a system which enables online and offline interaction and collaboration.

### SUMMARY OF THE INVENTION

The invention provides a method, system and apparatus which may, during online communications, retrieve content and an online/offline agent tailored to the retrieved content, the computing device being used and the interactive application desired. Once retrieved, the content is stored in memory and the online/offline agent commences execution. The computing device may go offline while a user (which may be a human or machine such as another device) interacts with the content and a tracking agent portion of the online/offline agent tracks and stores the user's interactions. At any point the device may go back online (as a result of, for example, a user's selection or instruction, auto-discovery of network connection/channel availability, etc.) and communicate with a synchronization server- a device adapted to receive and interpret tracking data. Once in communication, the device uploads tracked data and, in some instances, receives additional content and/or instructions responsive to the tracked data uploaded. Additionally, and in some embodiments of the present invention, the device is enabled to communicate with other similar devices. During communication with these other devices, a device embodying the present invention may transfer an online/offline agent, content or tracked data. This inter-device or peer-to-peer communication may occur indirectly using conventional networks (e.g., a digital wireless or wire-line network) or directly (e.g., device-to-device communication using, for example, radio or infrared communication). Resulting from this inter-device communication, users of devices embodying aspects of the invention, may communicate and collaborate while offline from conventional networks.

Advantageously, embodiments of the present invention may enable online/offline interaction and collaboration which creates new business opportunities and new applications which exploit this architecture (e.g., new interactive entertainment, new role-playing games, etc.).

Additionally, some embodiments of the present invention may, advantageously, reduce the amount and frequency of over the air data exchange thereby reducing bandwidth consumption and air-time costs.

In one aspect of the invention there is provided a device for communication with intermittent networking comprising: a communications interface adapted to communicate with a communications network and another device for communication; an user interface for receiving user inputs; memory; a processor in communication with the memory, the communications interface and the user interface, the processor adapting the device to: track user inputs received through the user interface; store the tracked user inputs in the memory; using the communications interface, transmit data corresponding to the tracked user inputs to a synchronizer, the synchronizer being one of another device communication and a central server.

In a further aspect of the invention there is provided a computer readable media containing computer instructions, the instructions adapting a network enabled computing device to: while offline, track a user's interactions with content; while offline, store the tracked interactions in memory; and while online, transmit data corresponding to the user interactions to at least one of a synchronization server and another network enabled computing devices.

In a further aspect of the invention there is provided a method for communication with intermittent networking, the method comprising: while online, receiving instructions for tracking interactions with content; while offline, tracking user interactions with the content presented to a user; and while online, transmitting to at least one of a synchronization server data and another user device corresponding to the tracked user interactions.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The present invention will be more clearly understood with reference to the following detailed description read in conjunction with the drawings, in which:

FIG. 1 is block diagram of an interactive online/offline system exemplary of an embodiment of the present invention;

FIG. 2 is a block diagram of a first user device forming a portion of the online/offline system of FIG. 1;

FIGS. 34 are functional block diagrams of an embodiment of the user device of FIG. 2;

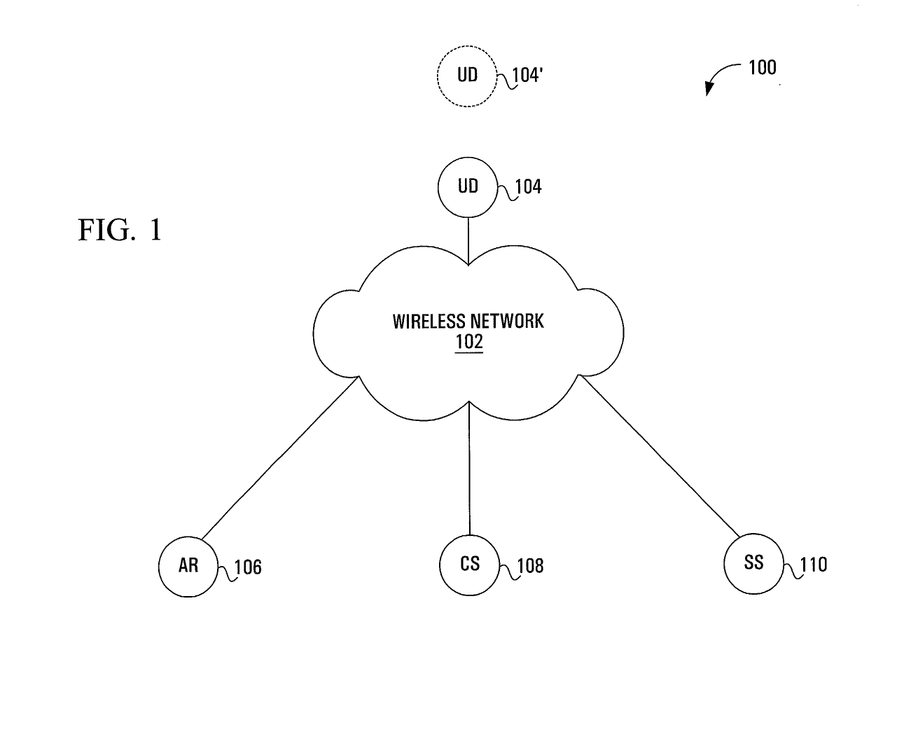

FIGS. 5-6 are flow charts of operations performed by the system of FIG. 1, the operations exemplifying embodiments of the present invention;

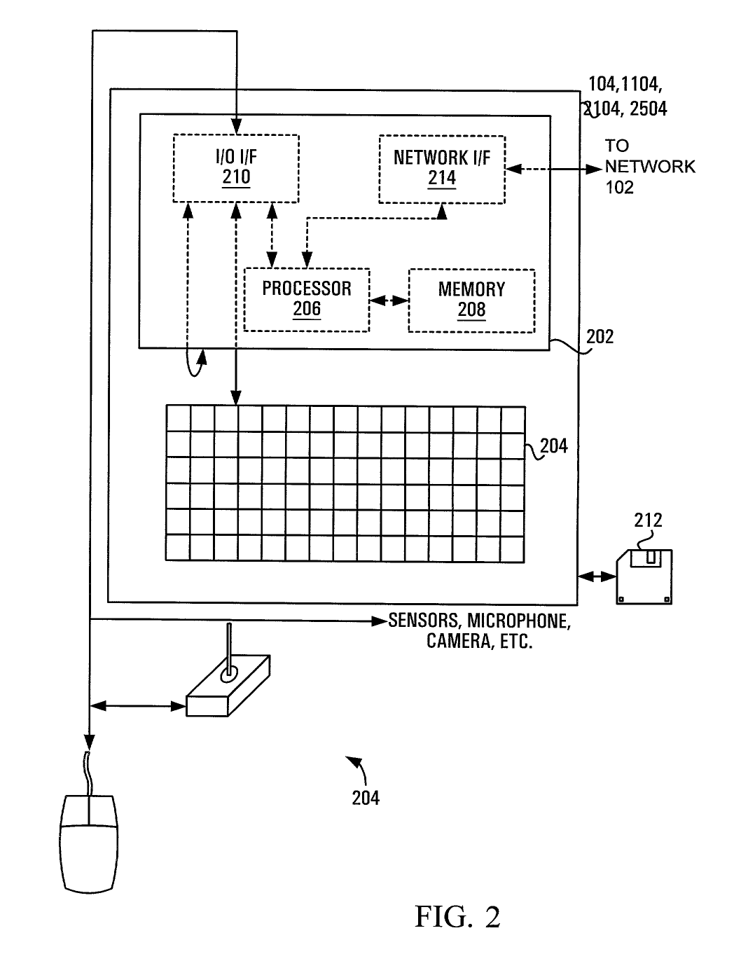

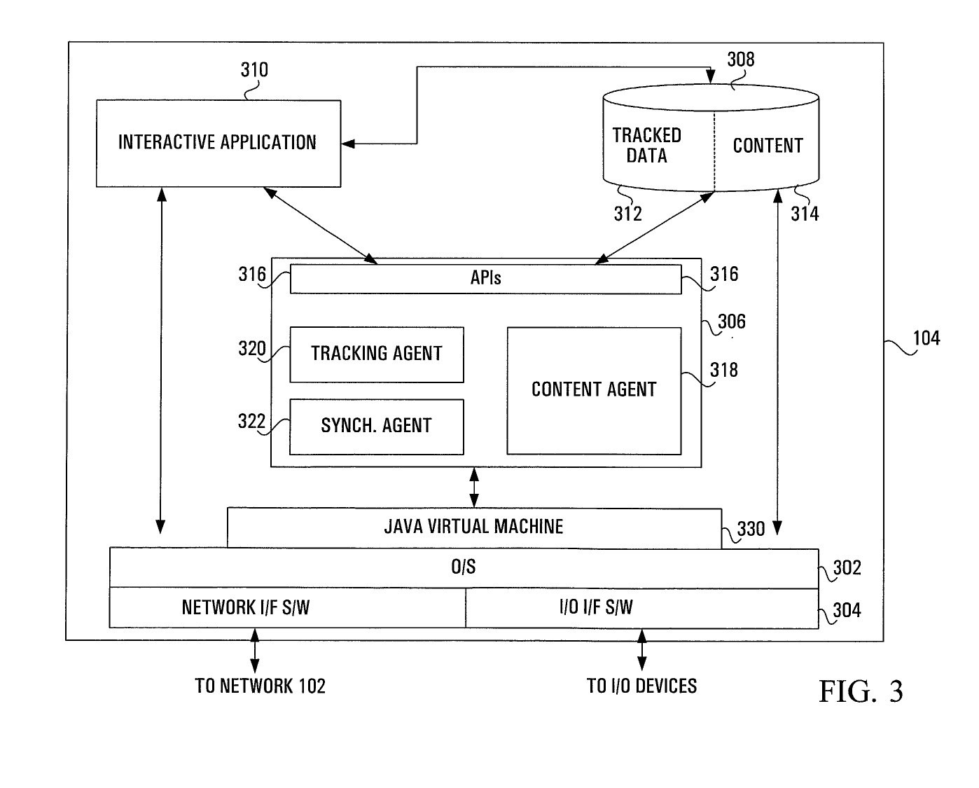

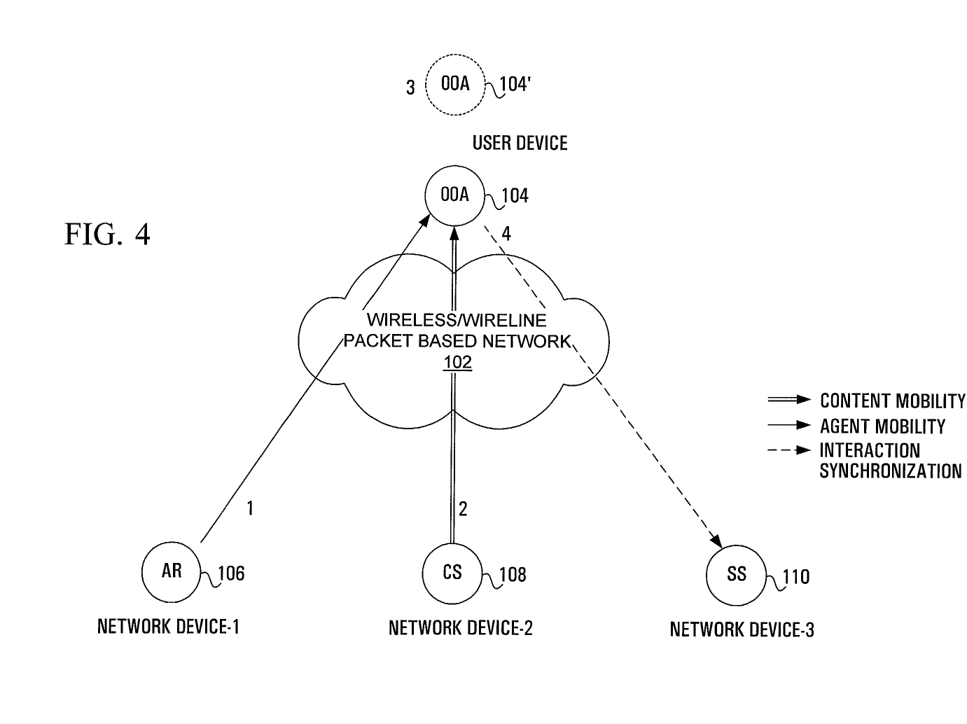

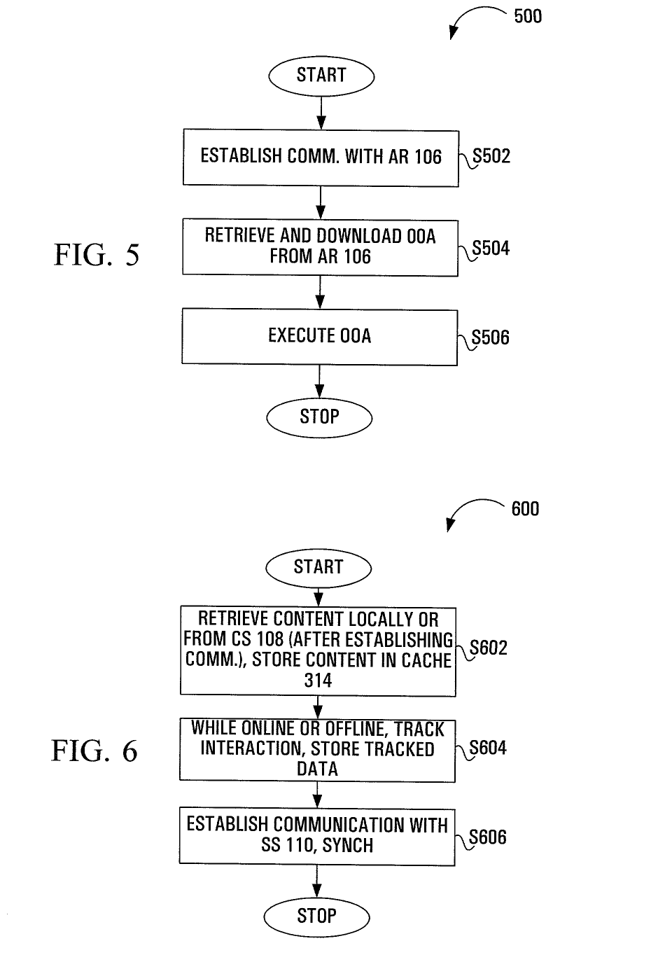

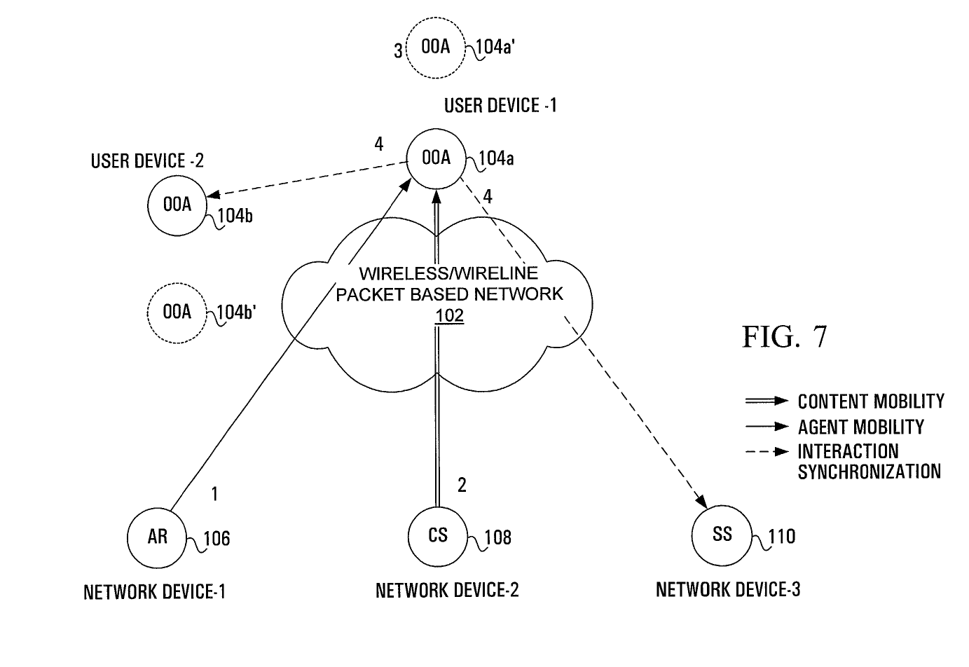

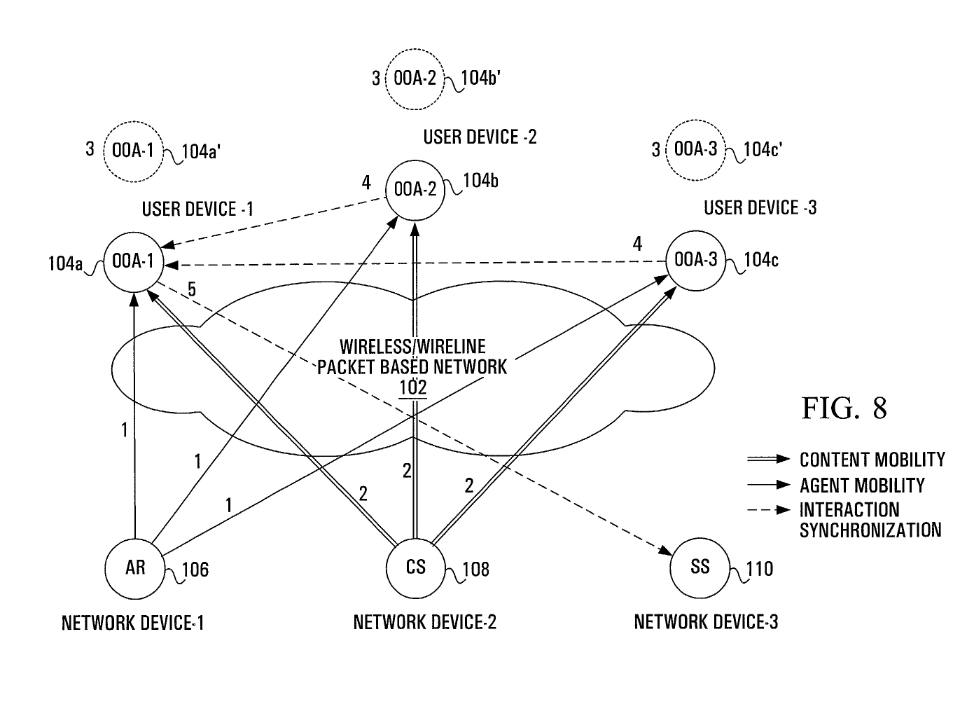

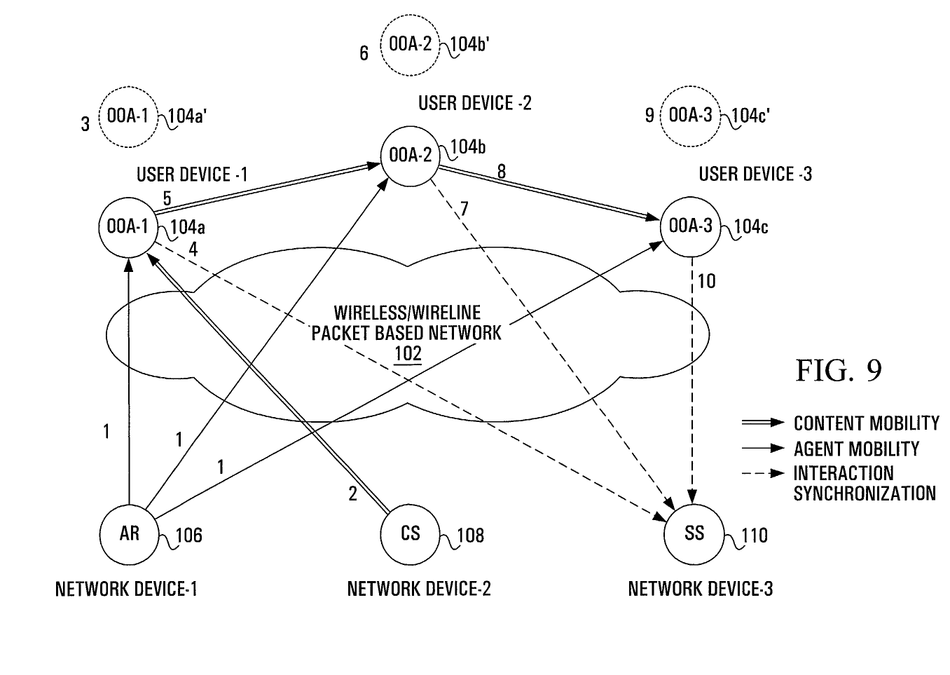

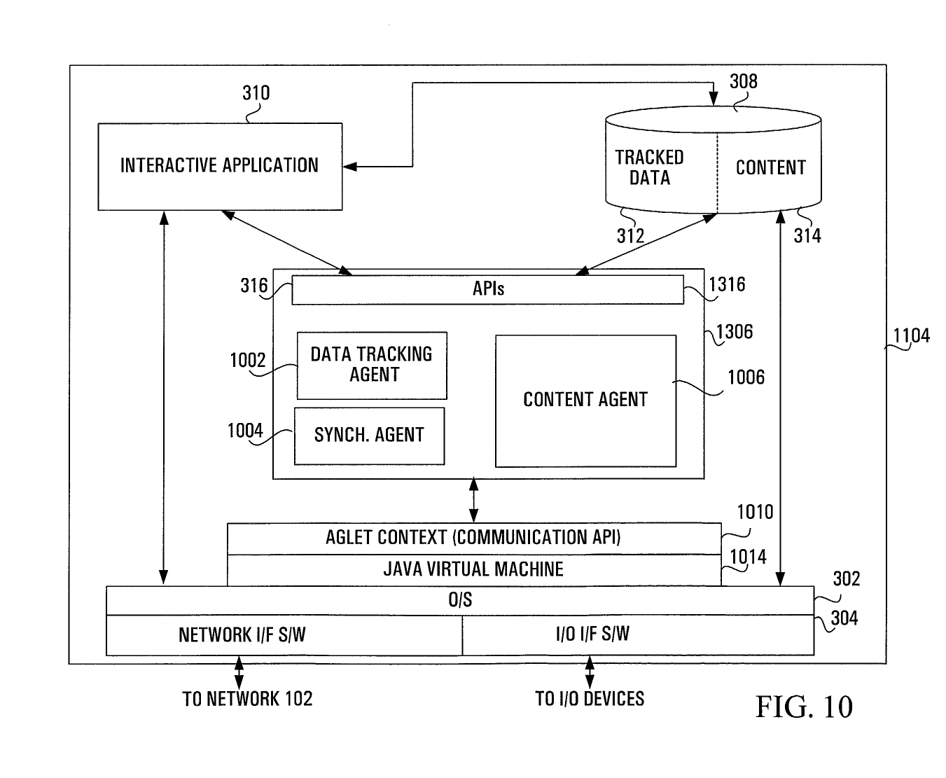

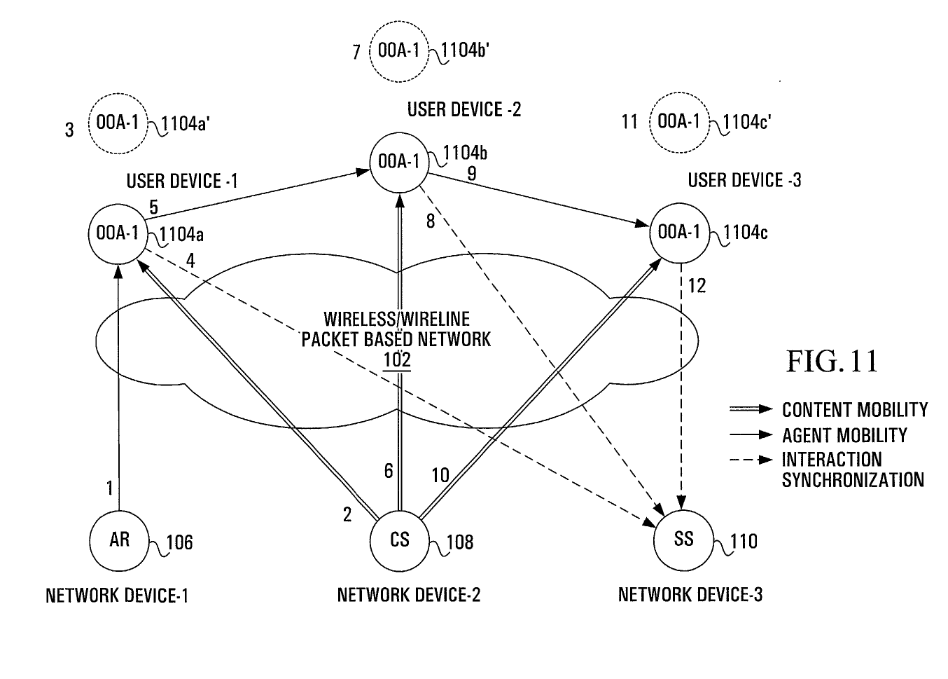

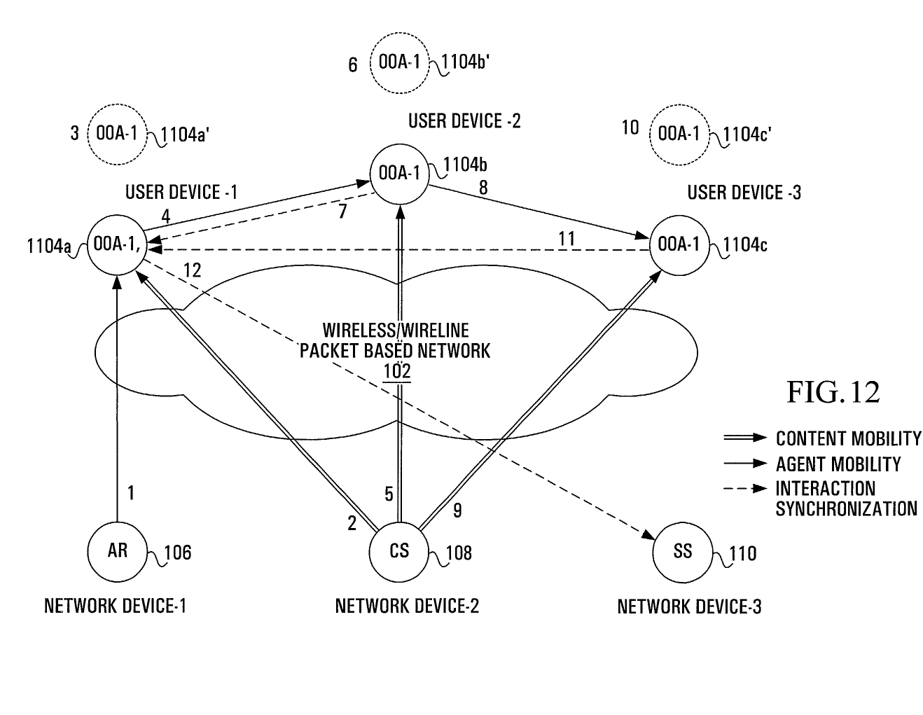

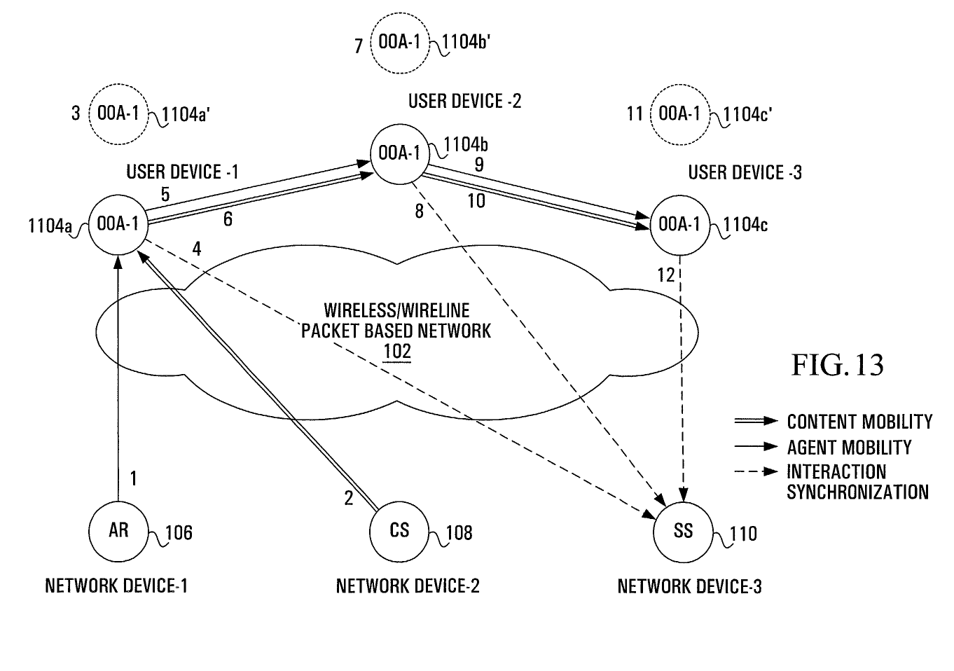

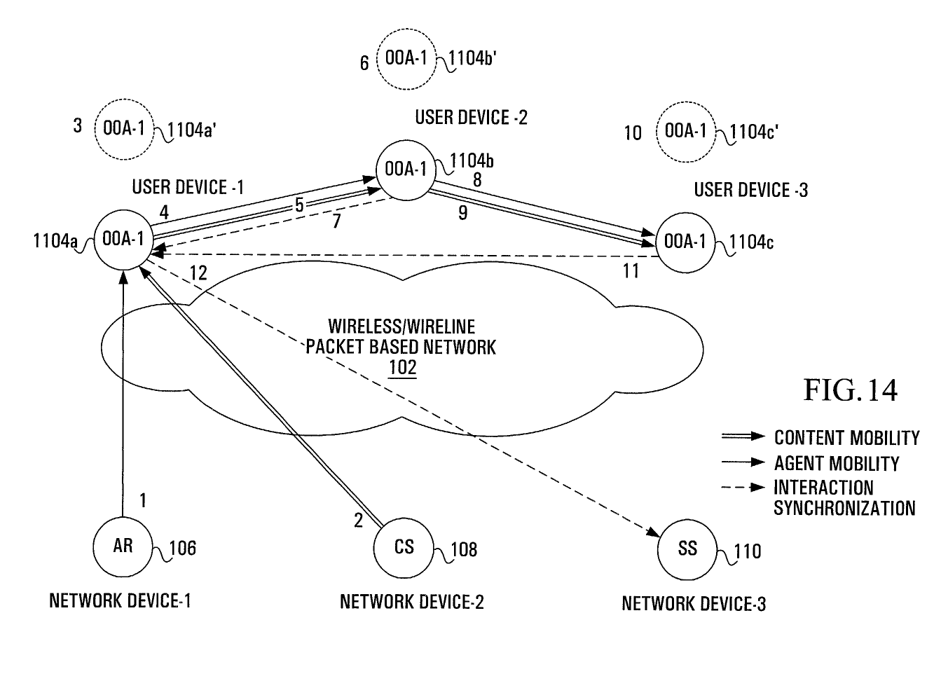

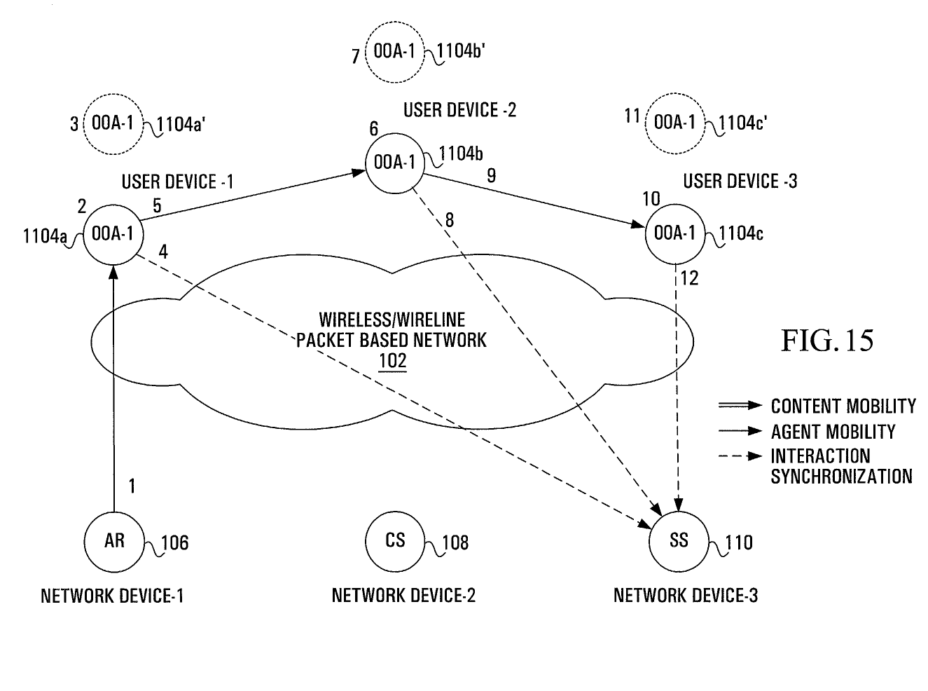

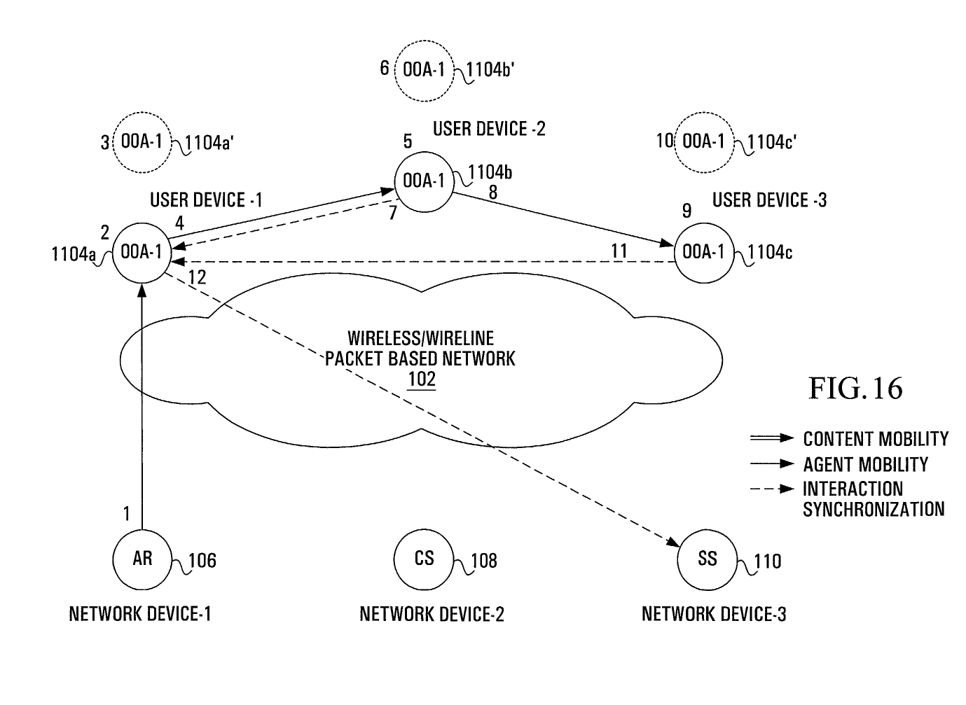

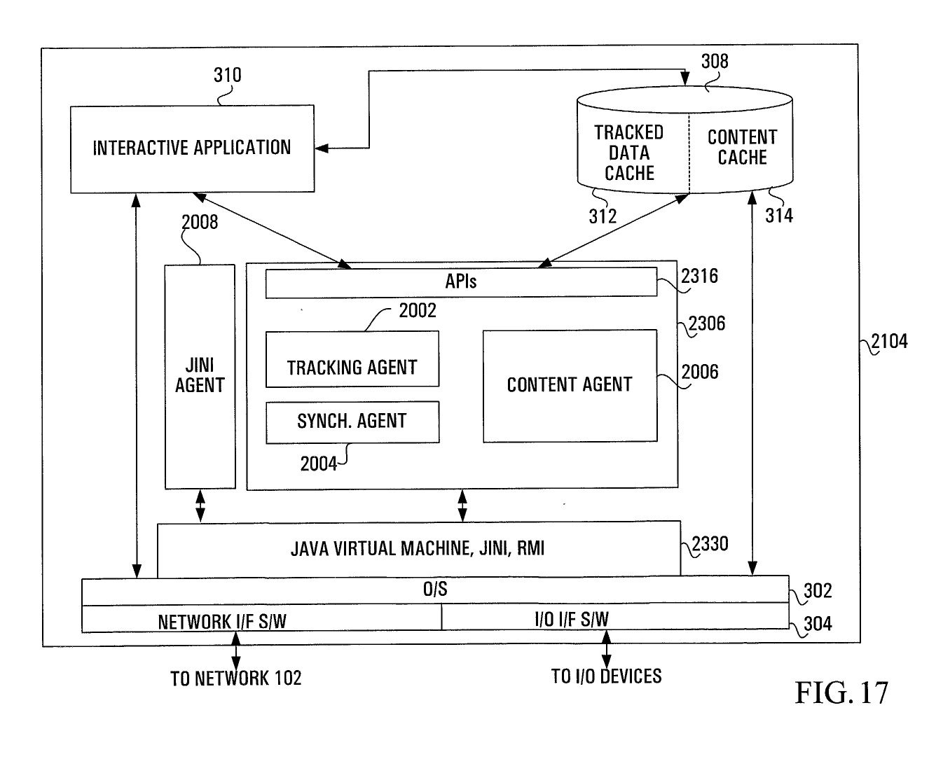

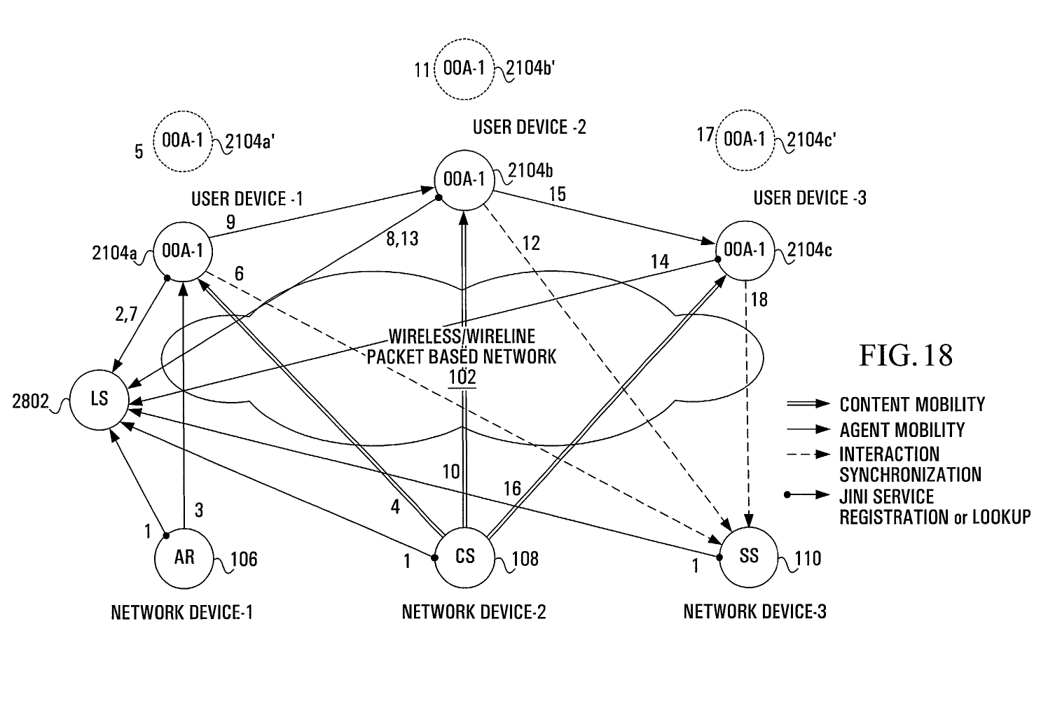

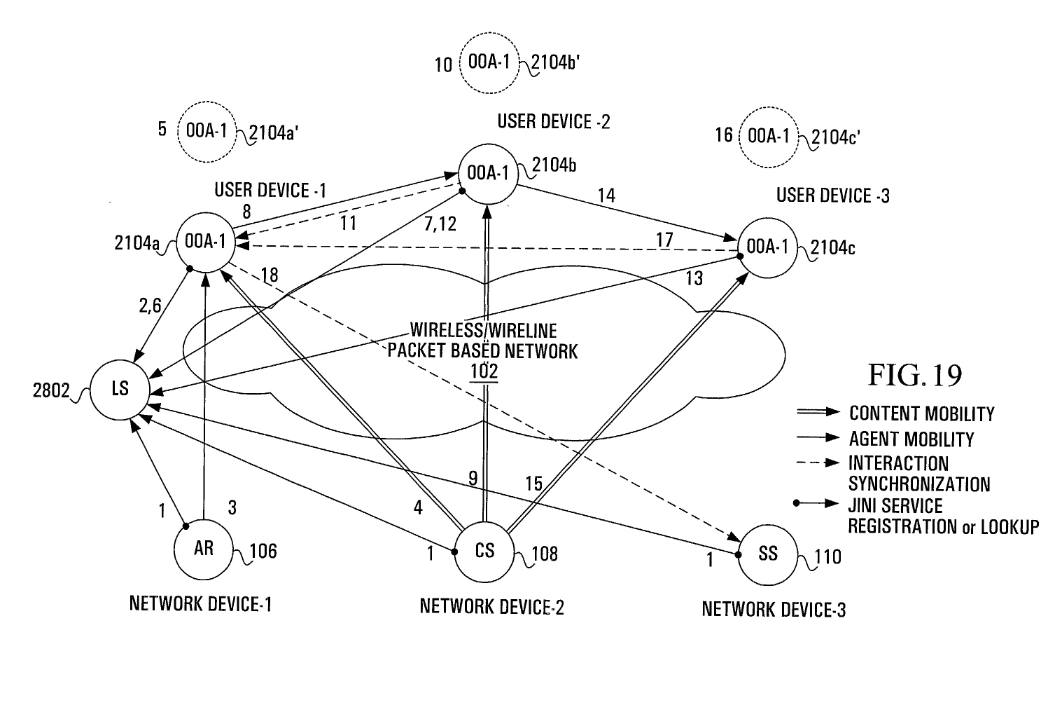

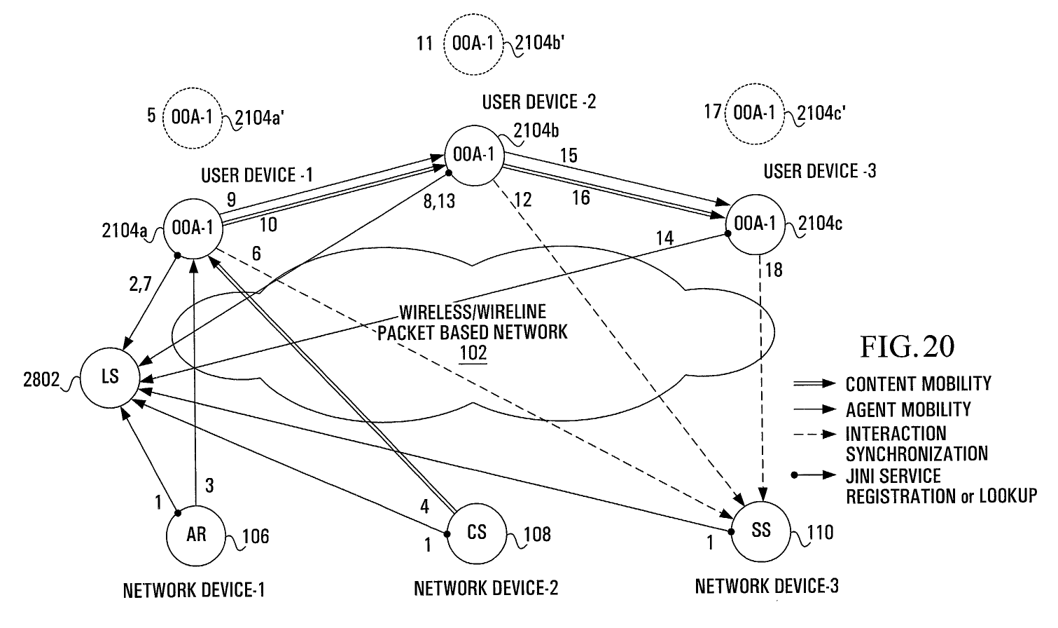

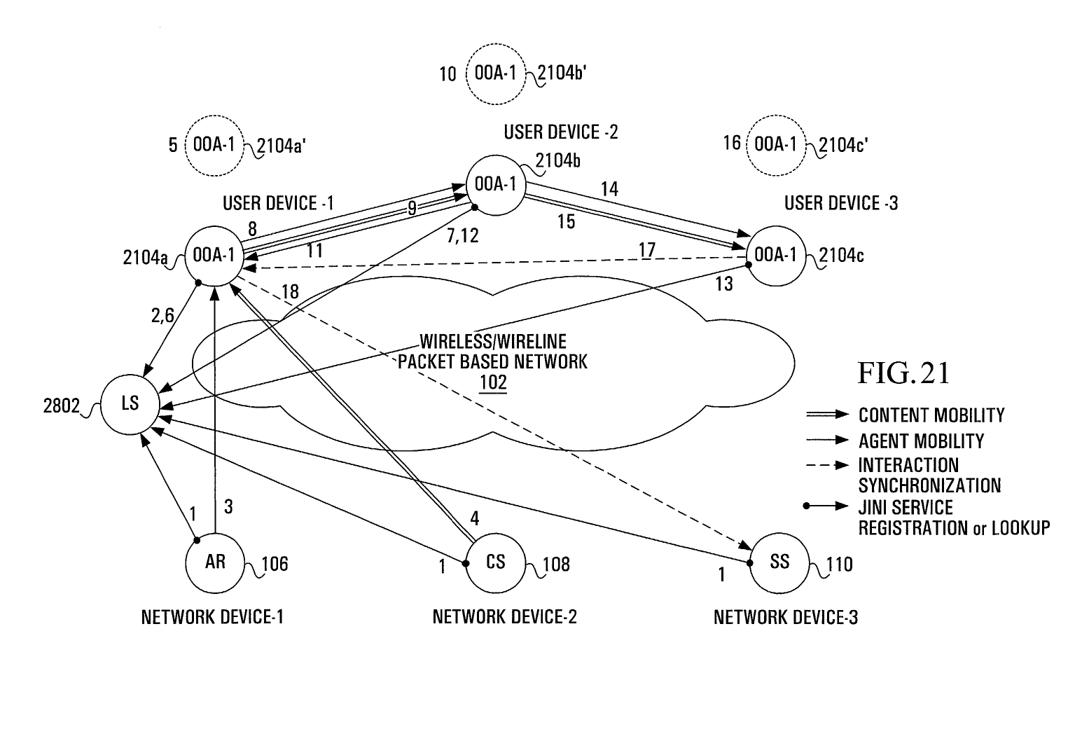

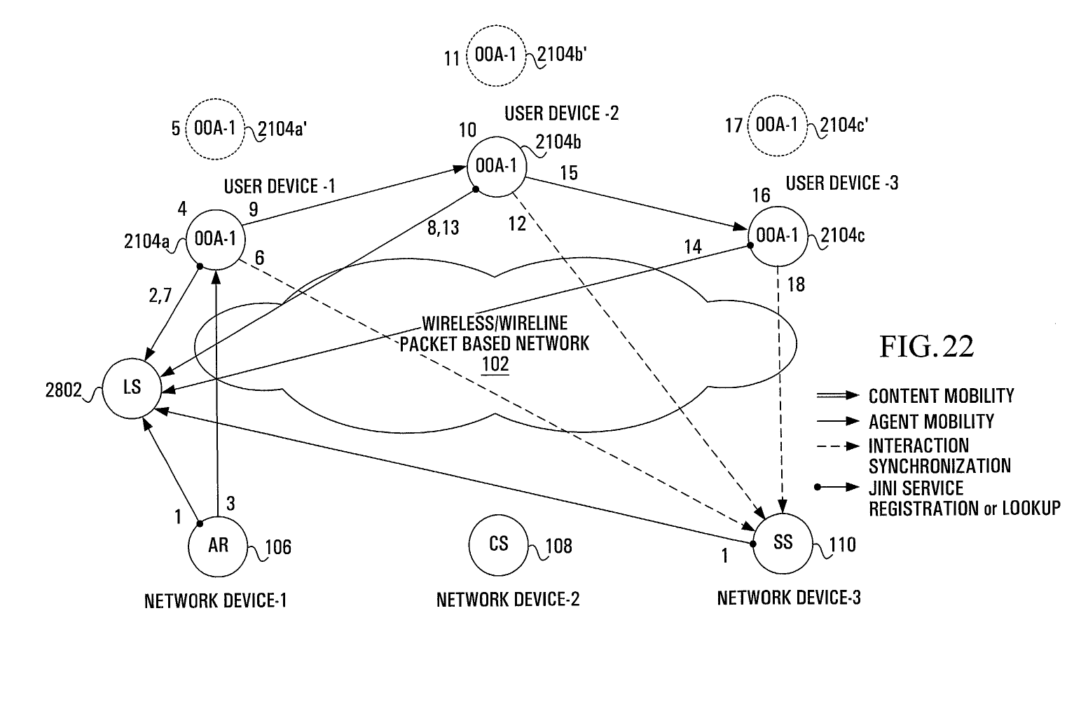

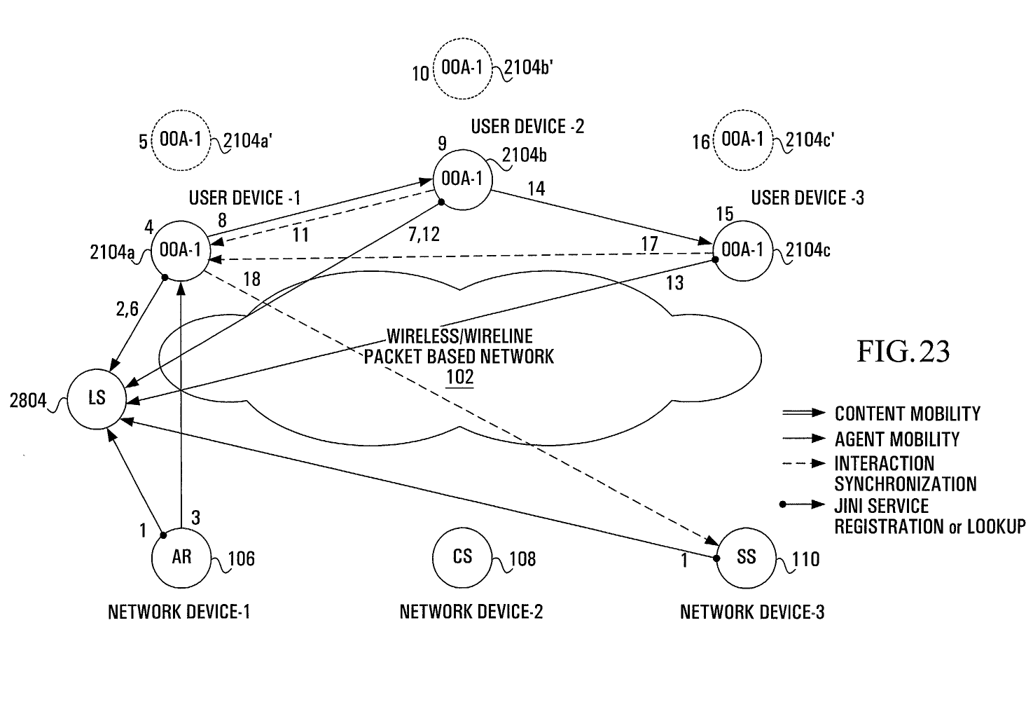

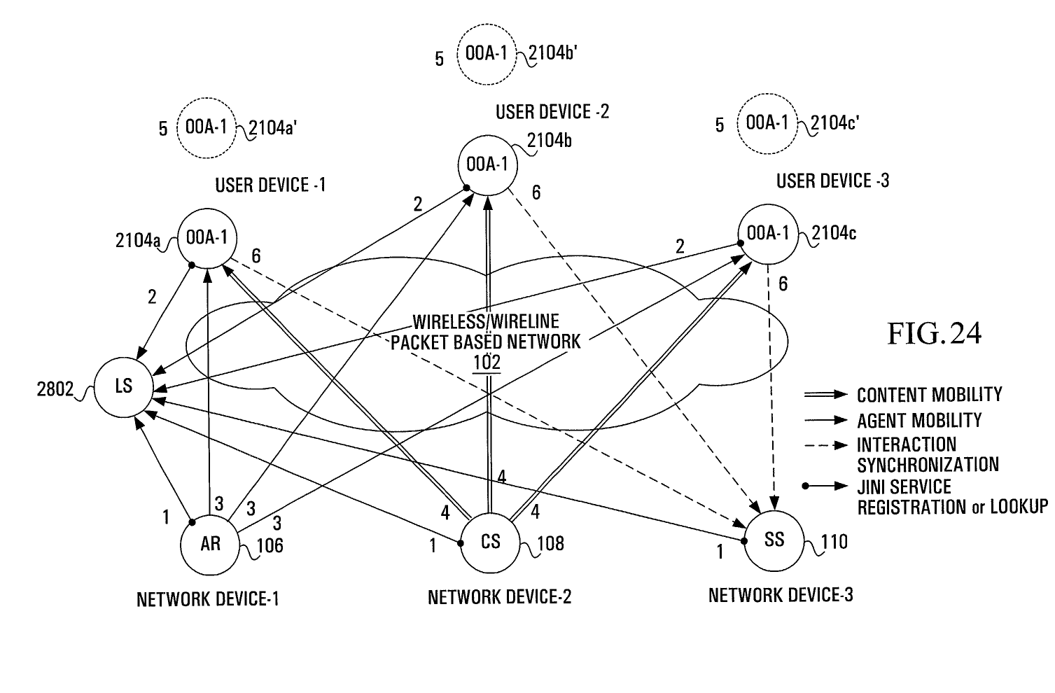

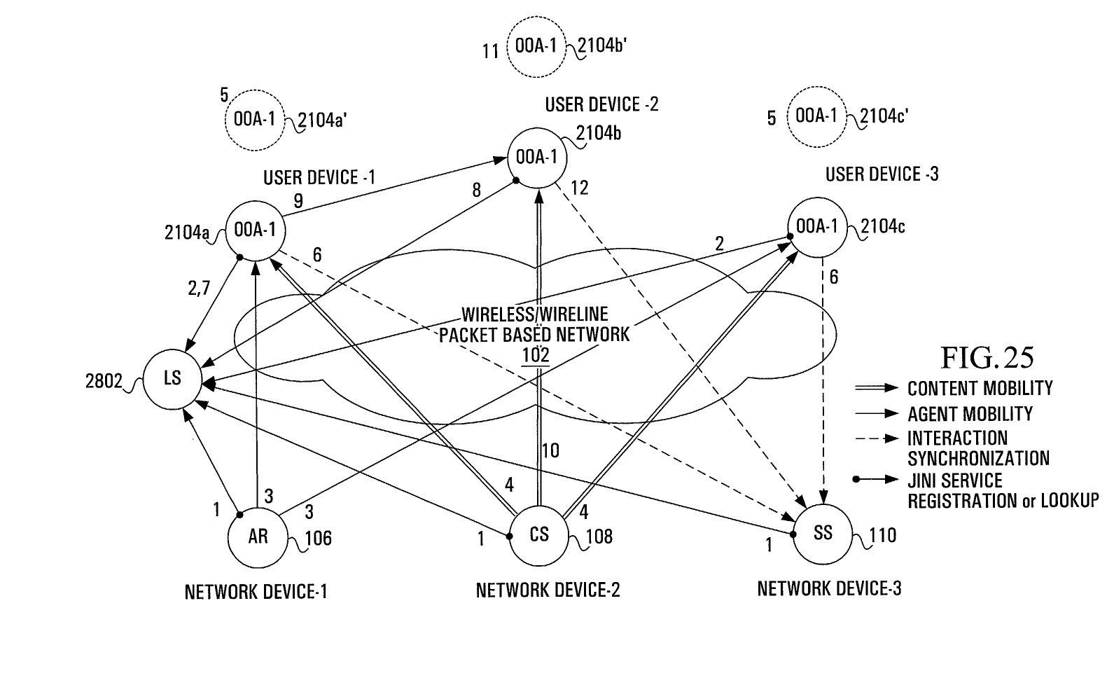

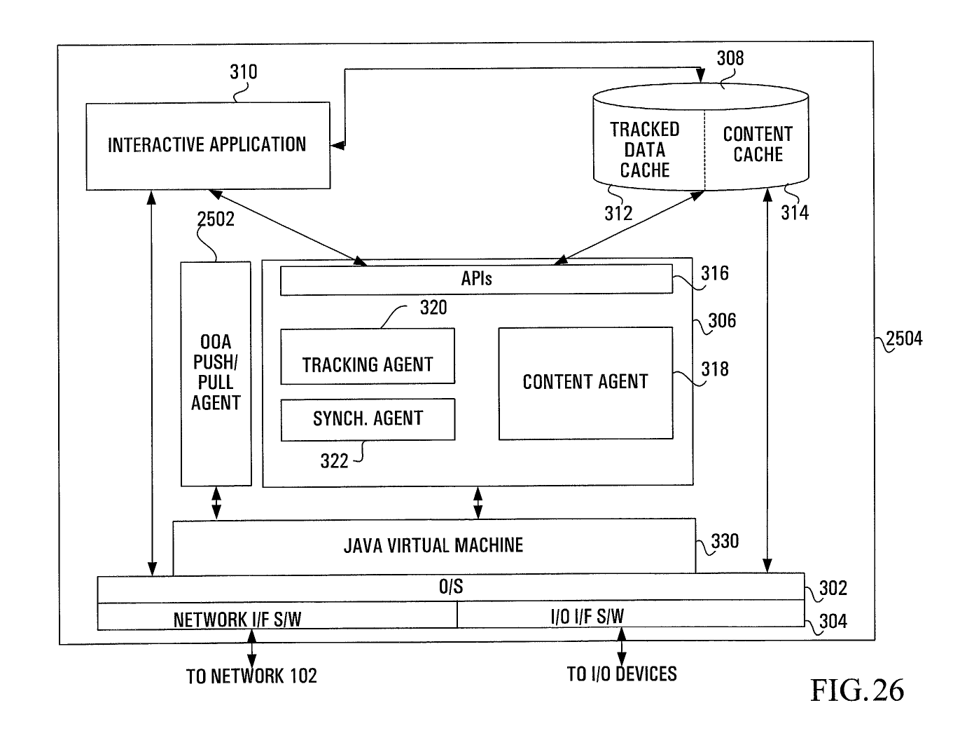

FIGS. 7-9 are functional block diagrams of an embodiment of the system of FIG. I having a plurality of interacting user devices of FIG. 2 in a collaborative environment;

FIG. 10 is a block diagram of a further embodiment of a portion of the user device of FIG. 2;

FIGS. 11-16 are embodiments of the system of FIG. 1, the operations exemplifying embodiments of the present invention including devices illustrated in FIG. 10;

FIG. 17 is a block diagram of a further embodiment of a portion of the user device of FIG. 2;

FIGS. 18-25 are embodiments of the system of FIG. 1, the operations exemplifying embodiments of the present invention including devices illustrated in FIG. 17; and

FIG. 26 block diagram of a further embodiment of a portion of the user device of FIG. 2.

The lines indicative of data flows in FIGS. 4, 7-9, 11-16 and 18-25 labelled with numbers with values less than 100 indicate the relative order in which data flow occurs (i.e., a data flow indicated by a line labelled “1” will occur before a data flow indicated by a line labelled “2”). For data flows which may occur simultaneously, more than one line indicative of this parallel data flow is labelled with the same number. The order of data flows indicated by these reference numbers is only exemplary of embodiments of the present invention. Other orders and other data flows may be included in other embodiments.

### DETAILED DESCRIPTION

An interactive online/offline system 100 exemplary of an embodiment of the present invention is illustrated in FIG. 1. System 100 includes a user device (UD) 104 communicating over a wireless (or wireline) network 102 with an agent repository (AR) 106, a content server (CS) 108 and a synchronization server (SS) 110. As will be appreciated by those of ordinary skill in the art, only a single example of each of the various devices (e.g., UD 104, AR 106, CS 108 and SS 110) has been illustrated for ease of understanding. In many embodiments of the invention, an AR, CS or SS would service many UDs 104. Additionally, a single UD 104 may communicate with one or more ARs 106, CSs 108 and SSs 110 over network 102. ARs 106, CSs 108 and SSs 110 may be colocated or distributed throughout network 102. Network 102, although illustrated as a wireless network, could also include dial, cable, DSL or optical access technologies.

UD 104 may be online (illustrated by solid lines) or offline (indicated by dashed lines and designated 104′). UD 104 may be a conventional wireless computing device (e.g., a Palm™ computer available from Palm Computer Corp., a conventional notebook computer, a mobile telephone with data capability, a gaming device, etc.) adapted to perform the functions described herein. Exemplary embodiments of UD 104 are illustrated in greater detail in FIGS. 2, 3, 10, 17 and 26 (described below).

AR 106 is a conventional computer server in communication with network 102 which has been adapted to provide UD 104 with device specific and/or application specific and/or content specific downloads of online/offline agents (OOAs). AR may be in communication with other networks (such as an intranet or the internet)—which is not shown. An OOA provides tracking agent (TA) functionality, content agent (CA) functionality and synchronization agent (SA) functionality as a single bundle. However, as will be appreciated, alternative embodiments of the invention may provide the TA, CA and SA separately which may, in various combinations, provide the functionality of an OOA. These OOAs once downloaded from AR 106 to UD 104 will reside on and be executed by UD 104. As is described below, these agents may be implemented using JAVA™ based technologies which execute on top of a JAVA™ platform available from Sun Microsystems. OOAs could, in some embodiments, be implemented using applet technology. Additionally, AR 106 may locally store or remotely access user data corresponding to a user of UD 104. This user data may include a profile of the user, subscription information, personal preferences and other pertinent data. User data may be used by AR 106 to modify or adapt an OOA being downloaded by a UD 104 to personalize a user's further interaction with the agent, content or other servers (e.g., CS 108 or SS 110). In addition to allowing UD 104 to download (pull) OOA from AR 106, an AR 106 may also upload (push) OOA to UD 104 as required. As will be appreciated, an OOA may be downloaded (or uploaded) using protocols such as, for example, HTTP, FTP, proprietary socket based methods, or the like.

CS 108 is a conventional server in communication with network 102 which has been adapted to receive requests for content from UD 104 transmitted over network 102; assemble/encode content responsive to these requests; and transmit the assembled/encoded content to a UD 104 via network 102. CS 108 may be in communication with other networks (such as an intranet or the internet) - which is not shown. CS 108 may act as a proxy/gateway and, responsive to a request received from a UD 104, generate requests for content from other devices so that content can be assembled and transmitted to a UD 104 responsive to a request made by a UD 104. CS 108 may be a centralized server, local/distributed caching server or proxy server. The content provided by CS 108 may include, for example, forms, interactive applications 310, web site data, catalogs, games, MP3/MP4 files, MPEG4 video, hyper-video, online/offline agents, etc.

SS 110, also a conventional server in communication with network 102, is adapted to provide synchronization services to UDs 104. The synchronization engine implemented by SS 110 may use conventional or developing synchronization standards such the SynchML standard available from the SynchML organization at www.synchml.org. SS 110 processes (i.e., receives and interprets) data corresponding to tracked user interactions with content (the content having been rendered on a UD 104). Additionally or responsive to processed tracked data, SS 110 may provide a UD 104 with additional data or information as to where additional data may be obtained. SS 110 may be part of or interface with back-end systems for processing tracked information and ultimately delivering the desired service to the UD 104. For example, an SS 110 may communicate with one or more back-end systems such as, for example, e-commerce servers, customer relationship management systems, expense processing systems, billing systems, loyalty management systems, central directories/repositories or the like.

AR 106, CS 108 and SS 110 may be colocated or geographically distributed across network 102. Additionally, the functionality of AR 106, CS 108 and SS 110 may be implemented/resident within the same computing device or different computing devices/systems. Further, each of AR 106, CS 108 and SS 110 may be owned and operated by the same or different service providers and may communicate with each other directly or indirectly using intermediate systems such as a common database and/or back-end processing system that deliver the desired services to a UD 104. Additionally, AR 106, CS 108 and SS 110 may operate as web servers providing a web interface to a web browser executed by a UD.

As will be appreciated by those of ordinary skill in the art, the functions of servers 106, 108 and 110 could be combined in various combinations. For example, the functions of AR 106 and CS 108 could be combined resulting in a single server which would provide both online/offline agents and content to a user device.

For example, SS 110 may receive tracking data from a UD 104 which indicates the salespersons'(Salesperson “A”) interaction with an electronic expense report form (e.g. an expense form requiring supervisor approval). The supervisor having interacted with numerous other expense reports received from other salespersons (e.g., accepted or rejected submitted expense reports), may then, through the supervisor's UD 104, synchronize his/her interactions with the SS 110. SS 110 having previously synchronized with a salesperson “A”, may provide the new expense report data to the supervisor's UD 104 or, alternatively, point the supervisor's UD 104 to contact CS 108 for the updated data. Similarly, other salespersons having previously submitted various expense reports may, during later synchronization with SS 110, be provided with, or directed to, data indicating whether submitted expense reports have been accepted/rejected by the supervisor.

UD 104 is illustrated in greater detail in FIG. 2. UD 104 incorporates hardware available in conventional wireless devices including user interfaces 204 (e.g., a keyboard, mouse/pointer, a microphone or the like), processor 206 (e.g., an Intel Pentium class or Reduced Instruction Set Computer (RISC) chip or the like), memory 208 (which includes both persistent and volatile memory such as RAM, ROM, fixed disks and the like), input/output (I/O) interface (I/F) 210 and network interface (I/F) 214. UD 104 is also adapted to receive computer instructions (e.g., computer software, content, applications, plug-ins, etc.) from an external source 212 (illustrated in the exemplary illustration as a removable media). External source 212 may be, for example, a diskette, CD-ROM, flash memory card, or a remote source such as another UD, a computer or the like. Additionally, UD 104 may include other input and output devices specific to the operating environment. For example, in many environments sensors which record physical measurements are desirable. These sensors, as described in the examples below, may include electronic sensors for use in automotive telemetry applications, bio-sensors for measuring a patient's condition (e.g., heartbeat monitor, blood pressure, breathing rate, etc.) as well as many others. Accordingly, UD 104 may capture interactions through both on-board (e.g., keyboard, touch screen) or off-board I/O peripherals (e.g., sensors, microphones, digital cameras, etc.). UD 104 may be any type of network enabled information device such as, for example, a PDA, a notebook computer, a network enabled (e.g., telematic) automobile, wireless mobile handset, aircraft communication system or the like.

The functional blocks formed by software adapting UD 104 to perform the functions described herein are illustrated in FIG. 3. As will be appreciated by those of ordinary skill in the art, the delineations between functional components identified in FIG. 3 could be redefined while still falling within the spirit and scope of the invention described and claimed herein.

Software for UD 104 may be stored in memory 208 and executed by processor 206 (FIG. 2). UD 104 includes operating system (OS) 302 which provides basic low level functionality to UD 104. OS 302 may implement, for example, the Palm OS or Windows CE operating systems available from Palm Computer Co. or Microsoft, respectively. Network interface (I/F) driver software (S/W) 304 enables OS 302 to control the network I/F 214 (FIG. 2) for communicating with network 102 (FIG. 1). Network I/F driver SAN 304 may implement a suite of conventional communication protocols enabling communication over network 102 and with other devices. These protocols may include, for example, 802.11b (wireless LAN), Bluetooth™, IrDA, UMTS, GPRS, Ethernet, etc. I/O I/F driver S/W 304 enables OS 302 to control I/O I/F 210. Additionally, UD 104 includes OOA 306, interactive application 310 and local cache 308.

OOA 306 includes conventional application programming interfaces 316 which are adapted to enable the OOA 306 to interact with application 310 and cache 308. Such APIs may be specific to the interactive application and device OS 302. OOA 306 includes tracking agent (TA) 320, synchronization agent (SA) 322 and content agent (CA) 318. OOA 306 may be installed or provided to UD 104 upon user request (e.g., a user requests an OOA from an AR 106—i.e., “pulled” by the user), the OOA could be “pushed” to the UD 104 through various push technologies or installed from an external source 212. As will be appreciated, the OOA 306 could form part of content retrieved from CS 108.

Cache 308 contains records relating to interaction data 312 which has been tracked by TA 320 and content data 314 retrieved by CA 318.

Interactive application 310 may include any application with which a human/machine user of UD 104 interacts. For example, application 310 may be a web browser, a specialized electronic form management software, telephony program, interactive educational software, gaming software, hyper-video browser, custom software or a driver for interfacing with specialized input/output devices (e.g., heart monitor software, automotive telemetry software, biometric capture software, voice recognition software, image capture software, etc.). Interactive application 310 may be adapted to render (i.e., present to the user) content stored in content cache 314.

A TA 320, which forms part of OOA 306, will record a user's interaction with content rendered (e.g., displayed, presented, played, etc.) by a UD 104. This tracked data will then be stored by the TA 320 in cache 308 for later retrieval and synchronization (described below) with SS 110 or another UD 104. These interactions may include, for example, mouse clicks, selections, time spent interacting with application 310, user keypad entries/inputs, interactive game scores, user voice prompts, image captures, hyperlink selections, etc. and data received from off-board or external peripherals 204 (e.g., a thermocouple, oxygen sensor, electrodes used for heart rate monitoring, motion detectors, microphones, camera for biometrics capture, etc.). The data collected by TA 320 may depend upon the agent retrieved from AR 106, user profiles and preferences, content, application 310, method of access, physical location of a UD 104 during interaction, time of day, the UD 104 executing TA 320 and other parameters (i.e., a TA 320 is configured for the environment in which it will operate). TA 320 may also include policies which indicate what, when and how to track user's interaction with UD 104. Alternatively, policies may form part of content retrieved from CS 108. Data collected by TA 320 is stored in tracked data cache 312. Tracked data may be used to deliver the service desired by the user of UD 104. Tracked data may also be used to gather usage statistics and personalize further content, policies, agents, etc., delivered to UD 104. As will be described in greater detail below with reference to FIGS. 11-16, an OOA 306 may stay resident on a particular UD 104, or during collaborative communications, an OOA 306 may be transmitted to another UD 104.

Synchronization agent (SA) 322, which forms part of OOA 306, interacts with SS 110 to provide synchronization services to UD 104. SA 322 may be implemented using the client services described in the above noted SynchML standard. During communication with SS 110, SA 322 operates to interface with local cache 308, retrieve tracked data and profiles, and transmit the retrieved data to SS 110. Also during communication with SS 110, SA 322 operates to receive data from SS 110 and store this in local cache 308, allowing synchronization in both directions.

Content agent (CA) 318, which forms part of OOA 306, interacts with CS 108 to retrieve content required by a user of UD 104. A request for content may be received by CA 318 from SA 322 or interactive application 310. Responsive to a received request, CA 318 operates to communicate with CS 108 to retrieve the required content or retrieve the requested content from cache 314. Content retrieved from another device is stored by CA 318 in content cache 314. Additionally, CA 318 intercepts conventional interactions with interactive application 310. If the intercepted interactions indicate a request for content which is stored locally (e.g., in content cache 314 or in other memory), CA 318 will retrieve the requested local content and communicate the retrieved content to interactive application 310. If the content is not available locally, and the UD 104 is online, then CA 318 will contact the appropriate device storing the requested content (e.g., CS 108) and retrieve the requested content. Alternatively, CA 318 may initiate a transition from offline to online so that a request for content can be fulfilled. If UD 104 is offline and the content requested is not available locally, the request may be stored by CA 318 in tracked data cache 312 for processing when UD 104 is online. In this instance, CA 318 may communicate data to interactive application 310 for rendering which indicates to the user of UD 104 that the content is temporarily unavailable (e.g., a page for display, a warning sound or message, etc. which is rendered by interactive application 310). As a result, the user of UD 104 may continue to interact with other locally available content rather than waiting for UD 104 to go online. CA 318 may automatically retrieve/refresh content periodically as a background process whenever the UD 104 goes or remains online.

Both CA 318 and SA 322 may include a client function and server function. The SA client function retrieves tracked data from cache 308 and synchronizes with a SS 110 or other SAs 322 operating in server mode on other UDs 104. The SA server function of SA 322 operates to receive tracked data from other UDs 104 which is then stored in cache 308 for processing (e.g., later transmission to a SS 110). The CA client function retrieves and refreshes content stored in CS 108 or cache 308 of a UD 104. The CA server function retrieves content in cache 308 of UD 104 and provides (“pushes”) them to requesting UDs 104.

FIGS. 4-25 illustrate three architectures which embody aspects of the present invention. FIGS. 4-9 illustrate a stationary agent based online/offline architecture. In the stationary architecture, an agent is installed in a UD and stays resident in the UD. FIGS. 10-16 illustrate a mobile agent based architecture for the online/offline system. In this exemplary architecture the agent uses aglet technology to form relatively autonomous agents which may be transmitted between devices. FIGS. 17-25 also illustrate a mobile agent based architecture. However, in this latter exemplary embodiment, the agent is JINI based, non-autonomous and retrievable. A third architecture for agent mobility is illustrated in FIG. 26. Here, an agent may be transmitted between devices using an OOA push/pull agent.

FIGS. 4-9 illustrate several operational embodiments of the stationary agent based architecture of the present invention.

FIGS. 4, 5 and 6 illustrate the operation of a single UD 104 which operates without collaboration with another UD. A user, desiring to interact with content (e.g., a supplier's catalog of products that is viewable using a web browser - an interactive application 310) during a session which may include several communication disrupting events (e.g., network 102 is a wireless network which may result in “outages”, or the user desires to interact with the content in a disconnected manner), operates UD 104 (operations 500-FIG. 5) and UD 104 goes online and initiates a session with AR 106 (S502). Using the browser, for example, a user device may subscribe to online/offline services. The subscription may result in an OOA 306 being downloaded or otherwise installed into the UD 104. Although, in the examples described herein, the OOA 306 is downloaded from an AR 106, the OOA 306 could equally be installed from another medium. A communications session between UD 104 and AR 106 may be initiated by the user directly or through/during interaction with application 310. For example, a user may be provided with a supplier's catalog of products on CD-ROM readable by UD 104 viewable by a browser (application 310). As a result of rendering the first page of the catalog, application 310 may instruct UD 104 to: initiate communication session via network 102; connect with a particular AR 106; download a particular OOA 306 from the selected AR 106; and commence running or executing the downloaded OOA 306. The particular OOA 306 is selected based upon the content (e.g., supplier's catalog), the interactive application and parameters of the particular UD 104 being employed. The OOA 306 and related interaction instructions/policies may be selected based on other criteria (e.g., user input, privacy and/or security requirements, etc.).

Regardless of the event which initiates communication between UD 104 and AR 106, UD 104 may identify the user to AR 106 so that AR 106 can retrieve a profile for the user of UD 104. As indicated above, other information may be provided by UD 104 to AR 106 including, for example, the type of device of UD 104, the location of device, the type of content with which the user desires to interact, the bandwidth available, the interactive application available, etc. Responsive to this request, a OOA 306 is retrieved by AR 106 (which may be local to AR 106 or stored on a remote server) (S504). The OOA 306 requested is transmitted to UD 104 and is executed thereon (S506).

After acquiring a OOA 306, the user of UD 104, by way of operations 600 (FIG. 6) can interact with content locally or content retrieved from CS 108 (S602). If the content for which interaction is desired is remote (i.e., not local to UD 104), UD 104 may initiate a communication session with CS 108, via network 102, to retrieve the desired content (S602). Content retrieved from CS 108 or from a local source will be stored in content cache 314 for quick retrieval. The content retrieved (whether remote or local) may include policies that instruct TA 320 how, what and when to track interactions with such content. For example, a retrieved educational program may include policies to instruct TA 320 to track any lesson that was repeated, test answers and scores. Repeated lesson information may then be used by the educational supplier (after synchronization has occurred described below) to modify the materials to better assist and train students. In a further example, content retrieved from a supplier may instruct TA 320 to only track items selected for purchase and associated information (e.g., quantities required, shipment information, payment information, etc.). Data tracking by TA 320 will be stored in tracked data cache 312.

As will be appreciated by those skilled in the art, and as indicated above, the content may in fact simply be that resulting from the execution of TA 320 and the interaction of the user with UD 104. For example, a user's interaction with a UD 104 equipped with a heart monitor sensor and executing a TA 320 to monitor a user's heart rate may simply involve the user carrying out their daily activities. The TA 320 during this time will simply monitor and store information in tracked data cache 312 about the user's heart functions. The heart functions tracked, the interval periods of tracking, etc., may be part of TA 320 or downloaded policies that modify the operation of a generic heart monitoring TA 320. The “content” in this instance is simply the user's interaction with the UD 104.

In many instances, after any necessary content has been retrieved from a remote source UD 104 will go “offline” (i.e., terminating or suspending an open communications session—UD 104 has transitioned to UD 104′). During interaction with content retrieved, UD 104′, through operation of TA 320 and the use of any policies which were also retrieved from either AR 106 or CS 108, will track a user's interactions with local content. The tracked interactions are stored in tracked data cache 312 (S604). The content retrieved by UD 104 and stored in content cache 314 may, in many instances, be more than a simple Hypertext Markup Language (HTML)/Extensible Markup Language (XML) page. The content may also include interactive games, music, video, hyper-video, forms, executable application code, graphics, etc. In an example where a customer desires to access a clothing retailer's web site and browse the catalog, CA 318 may, based on the selection made by the user, retrieve the retailer's entire catalog rather than simply a page of data (as is the case in many conventional systems). The entire catalog would then be stored in content cache 314 enabling UD 104/104′to access the catalog, enter purchase requests, etc.. Interactions with the catalog (and all such content) may then occur regardless of the whether UD 104 is online or offline.

During a user's interaction with content stored in content cache 314, UD 104′may transition to UD 104 to communicate with CS 108 to retrieve additional information and/or additional policies. A similar transition may be initiated to retrieve an additional or replacement TA 320/OOA 306. After retrieval of any additional content/agent, UD 104 may then go offline—a transition back to UD 104′.

At any time UD 104′may transition to UD 104, thus going online, to communicate with SS 110. Interaction with SS 110 may involve one way (in either direction) or two way transfer of data so that the UD 104 can synchronize data with SS 110 (S606). Typically, most embodiments of the invention will involve the upload (from UD 104 to SS 110) of tracked data. For example, a user interacting with a supplier's catalog may communicate with SS 110 resulting in SA 322 retrieving tracked data from cache 312 indicating a purchase order form filled out offline together with requests for additional information regarding particular products/services, etc. The retrieved tracked data will then be transferred (i.e., uploaded) from UD 104 to SS 110. SS 110 may, during the communications session, download data to UD 104. This downloaded data may be data responsive to uploaded data (for example, requests for additional information or a confirmation number for a submitted purchase order) or may be other data. For example, SS 110 upon receipt of the tracked data from UD 104 may determine that some information has been requested by the user. In such a case, SS 110 may query CS 108 to provide the requested information. Responsive to this query, CS 108 may forward to SS 110 the information required (or a pointer thereto). SS 110 may then provide the updates (or the pointer) to UD 104. UD 104, responsive to receipt of updated information, updates content cache 314. If SS 110 provided UD 104 with a pointer to updated content, CA 318, responsive to the receipt of this pointer, may initiate communication with the CS 108 indicated by the pointer and retrieve the content indicated by the pointer for storage in content cache 314. For example, the user may have, in an earlier communications session, downloaded a supplier's catalog. The user, having gone offline for some time, may require updates to the catalog. Such updates could be provided during the above described scenario.

Additionally, SS 110 may provide UD 104 with updated policies. For example, in the heart monitoring example described above, TA 320 may be operating in accordance with certain policies (e.g., monitor the user's heart rate for one minute every ten minutes and upload this data every hour or as soon thereafter as possible). The data tracked by heart monitoring TA 320 is then provided to SS 110. As a result SS 110 is provided with hourly updates of the user's heart functions. A physician to the user, monitoring the data received by SS 110 (using perhaps another UD 104), may recognizing an undesirable condition, provide SS 110 with updated policies for TA 320 executing on UD 104. These updated policies may indicate, for example, the monitoring of a different parameter (e.g., blood pressure), issuing an alarm (either locally while offline or, at a remote location by going online) when a certain condition is reached or indicate that continuous monitoring the user's heart function is to be performed for the collection of additional data.

As will be appreciated by those of ordinary skill in the art, the embodiments of FIGS. 4-6 enable a user of UD 104 to interact with content offline (e.g., at their own pace without any worries related to connection failure or quality). Additionally, a user can be more efficient with their time as interaction with content is not dependent upon being in a online state. For example, a salesperson travelling by airplane (where wireless communications are presently prohibited or severely curtailed) could download a potential customer's web brochure on a site (rather than only a single page) prior to boarding the airplane and then, during the entire flight (an offline situation) study the potential customer's web brochure (which has been stored by CA 318 in cache 314) for aids in making a sale.

A second embodiment of the present invention is illustrated in FIG. 7 with operation of the embodiment in FIG. 7 discussed referencing FIGS. 5 and 6. The embodiment of FIG. 7, in contrast to FIG. 4, includes two UDs 104 (104a and 104b—collectively UDs 104). Further, UD 104b (functionally illustrated in FIG. 3), which can also transition between online (i.e., 104b) and offline (104b′), and also includes synchronization server functionality implemented in SA 322. The embodiment of FIG. 7 performs point (UD 104a) to multipoint (SS 110, UD 104b) synchronization. In the embodiment illustrated in FIG. 7, both UDs 104 perform operations 500 (FIG. 5) and 600 (FIG. 6) in a substantially similar manner as that described above. Unlike the examples described in conjunction with the embodiment of FIG. 4, UD 104a in S606 synchronizes with both SS 110 and UD 104b (through operation of SA 322).

For example, a junior and senior technician (UD 104a, 104b, respectively) may be required to perform maintenance services at a customer's site (a site away from the technicians' office). Accordingly, both technicians during or prior to travelling to the remote customer site, establish communication with AR 106 to download any required OOA 306 (S502, S504). The OOA 306 of each UD 104 is executed on each device (S506). In this example, TA 320 may be used to track the performance of any repairs requested by the customer. Both technicians also download the content required through CA 318 from S602 through operation of CA 318. The retrieved content is stored in the respective content cache 314 of UDs 104. The content retrieved may include, for example, forms, requests for service, requests for machine upgrades, technical manuals, troubleshooting guides and the like.

During the customer site visit, which may last for several hours or days, the technicians may retrieve and perform the service requests made by the customer identifying certain requests stored on their respective UDs 104 as completed (S604). The respective TAs 320 may also track the time taken to perform a task, the parts or supplies used, the manuals accessed etc. The tracked data, as in the previous embodiment and examples, is stored in tracked data cache 314. Additionally, the junior and senior technician may, during some period of time, tackle separate requests made by the customer. Accordingly, while each technician may not able to contact their head office to synchronize with SS 110, SA 322 operating on UD 104b enables UD 104a to synchronize with UD 104b. Accordingly, in the exemplary scenario, in S606 UD 104a will go online with UD 104b and establish a communication session. This communication may be conducted through network 102 or through another medium such as an infrared or wired connection.

During synchronization (S606) SA 322 of UD 104b operates to receive tracked data from UD 104a stored in and retrieved from tracked data cache 312 of UD 104a. As a result of this synchronization, the content and the various interactions with the content for both users are stored in UD 104b. In this way, UD 104b is updated (UD 104a may also, as a result of the synchronization be updated—by SA 322 retrieving tracked data from cache 314 of UD 104b and transferring to UD 104a.). Thereafter, either UD 104a or UD 104b may synchronize with SS 110. In an alternative embodiment, UD 104b would act as synchronization agent server for one or more UDs 104a and only UD 104b would synchronize with SS 110.

In FIG. 8 each UD 104 (UDs 104a, 104b and 104c) downloads OOA 306 from AR 106 and content from CS 108. However, unlike the previous examples, UDs 104b and 104c synchronize with UD 104a. Only UD 104a synchronizes centrally with SS 110.

A further alternative embodiment of present invention is illustrated in FIG. 9. In FIG. 9 three UDs 104 are present for exemplary purposes (UD 104a, 104b and 104c). Unlike previous embodiments, only one of the UDs 104 downloads content from a CS 108—UD 104a. After downloading content (and, perhaps, interacting with the content), UD 104a synchronizes with SS 110. However, and unlike previous examples, UD 104a communicates with and provides to UD 104b the content required by UD 104b. The content provided to UD 104b may be the content originally downloaded from CS 108 (including, if desired, modifications made by the user of UD 104a) or other content. UD 104b may also be provided with an address (e.g., a mobile number, a data address, etc.) of another UD (e.g., UD 104c) during synchronization with SS 110 or, alternatively, from a user's input into UD 104b or from a pre-determined list stored on UD 104b (e.g., an address book).

Utilizing the received address, UD 104b will establish communication with UD 104c and provide content to UD 104c. After receiving and interacting with the content received, UD 104c will synchronize with SS 110.

The exemplary embodiment illustrated in FIG. 9 provides users of embodiments of the present invention with the ability to easily communicate and collaborate with a community of other users. The exemplary embodiment of FIG. 9 may be particularly well adapted to a petition-like situation. For example, UD 104a may download a petition with signatures (digital or otherwise) being collected by the operator of SS 110. In this instance, UD 104a downloads a OOA 306 from AR 106 which operates to track when a user has executed the petition downloaded from CS 108. Upon execution, TA 320 instructs SA 322 to communicate and synchronize with SS 110. During the communication with SS 110, SA 322 retrieves the users execution data stored in tracked data cache 312 in UD 104a and transmits this data to SS 110. SS 110 may then provide UD 104a with an address of another interested and potential petitioner. Alternatively, the user of UD 104a may manually communicate with UD 104b—another party that may be interested in executing the petition. The same process of interacting with content, synchronizing with SS 110 (thus uploading signature from UD 104b) and communicating with another UD 104c can be repeated by UD 104b.

In an alternative to the embodiment of FIG. 9, UD 104b and UD 104c may synchronize with UD 104a. In this example, only UD 104a would centrally synchronize with SS 110. This may be preferable where the user of UD 104a is attempting to poll public opinion by going door to door in a neighborhood or randomly selecting people in a common or busy area (e.g., a public square, building or a mall). In this alternative, UD 104a would be enabled to synchronize with other UDs 104 by execution of SA 322 (FIG. 3). In such a case, UDs 104b, 104c would synchronize with UD 104a using synchronization agent client function 322.

A further embodiment of the present invention is illustrated in FIG. 10. Unlike previous embodiments, the stationary OOA 306 is replaced by an aglet-based mobile OOA.

The embodiment of FIG. 10 illustrates aglet based online/offline agents (OOA) 1306 forming part of aglet user devices (a-UD) 1104 (FIG. 11) which replace the agents 306 of UDs 104 illustrated in FIG. 3. An aglet is an autonomous mobile Java object based on, for example, Java™ object technology. Aglets allow active computation states to be stored on one device and later transmitted/restored on another device. Aglet context provides the fundamental functions for aglets to be created, managed and dispatched. Additionally, aglet context enables serialized aglets to be transferred to and received from other devices. Further, aglet context provides a uniform execution environment independent of the host/device capabilities. This latter characteristic isolates an aglet from the underlying operating system and environment. Aglets may be transferred using the Aglet Transport Protocol (ATP). As a result of the foregoing characteristics, aglets are autonomous Java objects (for example, running Java programming that includes byte code and state) that may be serialized and sent via the ATP. The itinerary of an aglet based OOA 1306 (i.e., the devices visited by the OOA) may be defined by the AR 106 or the a-UD 1104 prior to its departure. Other manners of defining an itinerary may also be employed.

OOA 1306 include APIs 1316 for enabling interaction between OOA 1306 with interactive application 310 and cache 308. Additionally each agent 1002, 1004 and 1006 of OOA 1306 communicates with device OS 302 via aglet context (and communication APIs) 1010.

An exemplary system using aglets is illustrated in FIG. 11. Much like the system illustrated in FIG. 4, FIG. 11 includes a plurality (three, as illustrated) of a-UDs 1104 (1104a, 1104b and 1104c) in communication with a network 102. Also in communication with network 102 is AR 106, CS 108 and SS 110. AR 106 in FIG. 11 stores aglet based OOA 1306 which can be selected and retrieved by a-UDs 1104. As in the previously described embodiment, OOA 1306 includes a tracking agent (TA) 1002, a content agent (CA) 1006 and a synchronization agent (SA) 1004. Similarly, CS 108 and SS 110 operate to communicate with CA 1006 and SA 1004, respectively. While it is contemplated that TA, CA and SA functions may be combined in various combinations, in many environments it may be preferable to keep these functions separate to enable independent customization and evolution.

In FIG. 11, OOA 1306 is transmitted from device to device, retrieving content from a CS 108, tracking user interactions and, while resident at a a-UD 1104, synchronizing tracked data with the SS 110. As in the example illustrated in FIG. 4, a-UD 1104a (FIG. 11) goes online and communicates with AR 106 via network 102. As a result of this communication, a-UD 1104a receives OOA 1306 which is then executed by a-UD 1104a. The communication between a-UD 1104a and AR 106 may be in any number of ways including, for example, manual initiation by the user, through instructions generated by interactive application 310, or through initiation by the AR 106 itself. a-UD 1104a then goes offline transitioning from a-UD 1104a to a-UD 1104a′. During user interaction with content stored in content cache 314, tracking agent 1002 will, much like TA 320 (FIG. 3), track user's interaction storing the results in tracked data cache 312.

a-UD 1104a′ also is adapted to transition to a-UD 1104a to commence online communication with a-UD 1104b. Communication between a-UD 1104a and 1104b may be initiated by the user manually or as a result of an event occurrence (e.g., a user selection, a timer, etc.). Communication between a-UD 1104a and 1104b may be indirect (e.g., using network 102) or direct (e.g., using, for example, infrared communication, Bluetooth, etc.).

During communication, OOA 1306 is transferred from a-UD 1104a to a-UD 1104b. OOA 1306 and hence, TA 1002, now resident on a-UD 1104b, is executed and TA 1002 commences tracking content interaction on a-UD 1104b. a-UD 1104b may also retrieve some of the user's interactions stored in tracked data cache 312 of a-UD 1104a.

a-UD 1104a also operates to synchronize with SS 110 through operation of synchronization agent 1004 (FIG. 10). As before, when required (e.g., subsequent to a user completing interactions with content on a-UD 1104b), OOA 1306 is transferred from a-UD 1104b to a-UD 1104c for execution on a-UD 1104c. Both a-UD 1104b and 1104c operate to obtain content from CS 108 and synchronize independently with SS 110.

As will be apparent by those skilled in the art, the embodiments illustrated in FIGS. 10 and 11 enable an aglet-based online/offline agent to “hop” between user devices. As now described in conjunction with the embodiments of FIGS. 12-16 this enables collaboration among a-UDs 1104 without requiring each a-UD 1104 to communicate with servers.

The embodiment of FIG. 12 illustrates a system where one a-UD 1104 (shown as a-UD 1104a) operates as a synchronization server for other a-UDs 1104. Accordingly, a-UD 1104a includes a SA server function 322 which operates to receive tracked data from a-UDs 1104b, 1104c. Consequently, only one (a-UD 1104a) of a plurality of a-UDs 1104 forming an ad hoc community of devices (e.g., within an ad-hoc wireless LAN environment) needs or should be able to synchronize with central SS 110. As before, a-UDs 1104b, 1104c will synchronize with a-UD 1104a using SA client function 1004.

The embodiment of FIG. 13 illustrates a system where both OOA 1306 and content retrieved from CS 108 by a-UD 1104a is transferred between a-UDs 1104b, 1104c. As a result, in this exemplary embodiment only one device (a-UD 1104a) need communicate with CS 108. In this embodiment each a-UD 1104 does synchronize independently with SS 110.

FIG. 14 illustrates a further embodiment of the present invention which effectively combines FIGS. 12 and 13. In the embodiment of FIG. 14 only one (a-UD 1104a) receives content from CS 108 and synchronizes centrally with SS 110. In this embodiment, both content retrieved from CS 108 and OOA 1306 is transferred from a-UD 1104a to a-UD 1104b and then to a-UD 1104c. Further, a-UDs 1104b, 1104c synchronize with a-UD 1104a rather than with SS 110.

FIG. 15 illustrates a variation to the embodiment illustrated in FIG. 13. However, in the embodiment of FIG. 15 the content with which a user interacts is either local to each a-UD 1104 or local to a-UD 1104a. In the latter instance, content local to a-UD 1104a is transferred, along with OOA 1306, between a-UD 1104a and another a-UD 1104. As in FIG. 13, each a-UD 1104 synchronizes independently with SS 110.

FIG. 16 illustrates a variation to the embodiment illustrated in FIG. 15. However, in the embodiment of FIG. 16 only one (a-UD 1104a) synchronizes with SS 110 while the remaining members of the ad hoc community of devices (e.g., a-UDs 1104b, 1104c) synchronize with a-UD 1104a. As in FIG. 15 content is not retrieved by any device from CS 108. Rather, content is local to each a-UD 1104 or is transferred between devices along with an OOA 1306.

As will be appreciated by those of ordinary skill in the art further variations using the architecture of FIG. 10 could be implemented within the scope of the present invention including various combinations of FIGS. 11-16.

A further embodiment of a UD embodying aspects of the present invention is illustrated in FIG. 17 as JINI™ based user devices j-UD 2104/2104′). (It should be noted that other protocols in addition to JINI™ which provide lookup services could also be employed. For example, the Services Lookup Protocol from the Internet Engineering Task Force (IETF) could be employed.) Similar to UD 104 (FIG. 3), j-UD 2104 includes interactive application 310, cache 308 (including tracked data cache 312 and content cache 314), online/offline agents 2306, operating system 302 and network interface software 304. Similar to UD 104, online/offline agent 2306 include interactive application and data interface APIs 2316, tracking agent 2002, synchronization agent 2004 and content agent 2006. Unlike UD 104, j-UD 2104 includes JINI agent software 2008 to enable j-UD 2104 to discover and register services (e.g., online/offline agent availability, content availability) with a lookup service (LS) 2802. The lookup service functionality is typically implemented or resident within a server different from a UD. However, the LS functionality may very well be implemented or resident on a UD. Lookup service servers 2802 may be local to the UD or remote/distributed across a network. Software for lookup service is embodied in the exemplary user device as JINI™ agent software 2008 executing on the Java™ Virtual Machine software 2330 both of which are adapted to perform the functions described herein.

FIG. 18 illustrates an environment in which j-UD 2104 may operate. Illustrated in FIG. 18 are a plurality (three, as illustrated) j-UDs 2104 (2104a, 2104b and 2104c) in communication with a network 102. Also in communication with network 102 are an AR 106, CS 108, SS 110 and Lookup Server (LS) 2802.

LS 2802 receives requests for service availability lookup and registration from j-UDs 2104 and other servers (e.g., AR 106, CS 108 and SS 110). A service may be defined as any information, software or content made available to other devices and the whereabouts or location of this information, service or content. For example, the availability of OOA 2306 from an AR 106 is a service that can be published on LS 2802. Other services, such as synchronization service availability, content availability, addresses of j-UDs 2104, ARs 106, CSs 106, and SSs 110 can also be looked-up/registered on LS 2802. A device is considered registered for service availability when a request for the service is lodged or logged with LS 2802. The request indicates that a specific device is interested in being notified of the availability of a service.

The operations of j-UD 2104 are best understood with reference to FIGS. 17 and 18. In FIG. 18, similar to FIG. 11, an OOA 2306 will be downloaded from AR 106 by a single j-UD 2104 (2104a in the illustrated embodiment). The OOA 2306 will then be transmitted between the remaining j-UDs 2104b, 2104c.

Each server illustrated in FIG. 18 (AR 106, CS 108 and SS 110) will have published the services each offers on LS 2802 by transmitting a request for registration to LS 2802 over network 102. j-UDs 2104 have also registered for service availability (i.e., availability notification) by each server 106,108,110. Accordingly, each j-UD 1702 will be notified by LS 2802 of the availability of the services originally requested. In the exemplary embodiment of FIG. 18, j-UD 2104a, having received notification of the availability of services from servers 106, 108, 110, contacts LS 2802 to determine the location of the desired OOA 2306 and content.

Notified by LS 2802 of the services available (via, for example, a paging channel), j-UD 2104a goes online and communicates with LS 2802 to determine the service provider for an OOA 2306 through operation of JINI agent software 2008. (It should be noted that j-UD 2104a may go online a significant time after being notified of the services available by LS 2802.) LS 2802 provides the address of AR 106, CS 108 and SS 110. Responsive to receiving the location of the provider for the desired OOA, j-UD 2104a communicates with AR 106 and downloads the required OOA 2306 which includes a tracking agent 2002, content agent 2006 and synchronization agent 2004. j-UD 2104a then downloads any requested/required content from CS 108.

As with other embodiments, j-UD 2104a is also able to provide OOA download services to another j-UD 2104 (e.g., j-UD 2104b). In one embodiment, j-UD 2104a initiates communication with LS 2802 (which may be local) and registers OOA download service availability. (A local LS could be used as a “local publishing board” in this case. Alternatively, another UD may serve as local LS). j-UD 2104b later initiates communication with LS 2802 and is provided the address of j-UD 2104a. OOA 2306 is transferred (i.e., downloaded) from j-UD 2104a to j-UD 2104b during communication between the two devices. A similar transfer of OOA 2306 occurs between j-UD 2104b and j-UD 2104c.

In FIG. 18 each j-UD 2104 synchronizes with SS 110 independently.

Additional embodiments of the invention including a LS 2802 are illustrated in FIGS. 19-25.

FIG. 19 illustrates an embodiment of the invention similar to FIG. 18. However, unlike the embodiment of FIG. 18, each j-UD 2104b, 2104c synchronizes with j-UD 2104a. Only j-UD 2104a synchronizes with SS 110. j-UD 2104a in this case registers both synchronization service availability and OOA download service availability with LS 2802.

FIG. 20 illustrates an embodiment of the invention with only one j-UD 2104 (2104a) retrieving content from CS 108. In this embodiment, j-UD 2104a transmits both content and OOA 2306 to another j-UD 2104 (2104b). Each j-UD 2104 synchronizes with SS 110 independently. Transfer of content and OOA 2306 is then repeated as required.

FIG. 21 illustrates a combination of FIGS. 19 and 20. In this embodiment, only one j-UD 2104 (2104a) retrieves content from and synchronizes with the central servers (CS 108, SS 110).

FIG. 22 illustrates an embodiment where the content required by each j-UD 2104 is local to each j-UD 2104 and may be transferred between j-UDs 2104. Each j-UD 2104 synchronizes with SS 110 independently.

FIG. 23, like FIG. 22, illustrates an embodiment where content is local to each j-UD 2104 and maybe transferred between j-UDs 2104. Each j-UD 2104 synchronizes with a designated j-UD 2104 (e.g., 2104a).

FIG. 24 illustrates an embodiment of the invention where each j-UD 2104 operates independently of each other.

FIG. 25 illustrates an embodiment where some (e.g., j-UDs 2104a, 2104b) of the devices initiate communication to transfer OOA 2306 while other j-UDs 2104 (2104c) operate independently (i.e., downloading an OOA through direct communication with LS 2802 and AR 106). Alternatively, j-UDs 2104 (2104b, 2104c) may operate to download an OOA 2306 through direct communication with LS 2802 and j-UD 2104a.

FIG. 26 illustrates a further embodiment of the user device illustrated in FIG. 2. Like the embodiment illustrated in detail in FIGS. 3, 10 and 17, UD 2504 also provides online/offline functionality. However, UD 2504 includes OOA push/pull agent 2502 which operates to enable UD 2504 to either: “push” OOA 306 (i.e. the stationary OOA 306 illustrated in FIG. 3) to another UD 2504 or server; or “pull” OOA 306 from another UD 2504 or server. Additionally, and unlike a-UD 1104 (FIG. 10) where state and code of the aglet based OOA is transferred between user devices, UD 2504, through operation of the OOA push/pull agent 2502, only transfers OOA 306 code between user devices (i.e., no state data corresponding to the aglet based OOA is transferred). By “pulling” an agent from another user device, the need for an itinerary for agent transfer between user devices is eliminated. Once transferred to a user device, the CA 318 of OOA 306 may “push” or “pull” content to/from another UD 2504 or server. The operations illustrated in FIGS. 11-16 are also applicable to UD 2504 illustrated in FIG. 26.

As will be appreciated by those of ordinary skill in the art, embodiments of the invention may combine various combinations of stationary and mobile online/offline agents. Further, in mobile agent embodiments, it may be desirable to include some level of anonymity. For example, in many instances only the sender and receiver of the mobile agent need know of the agent's whereabouts and the user having directed the agent.

In large scale environments with reliable or simultaneous access to synchronization and publishing/registering services, it may be preferable to download content and an online/offline agent contemporaneously.

As will be appreciated by those of ordinary skill in the art, the delineations between tracking, synchronization and content agent portions of an online/offline agent are somewhat arbitrary. The various functions of the online/offline agent may be separated into various combinations and may be independently downloaded and assembled on a user device.

As will also be appreciated by those of ordinary skill in the art, while only one interactive application and one OOA was illustrated as resident in a user device, multiple interactive applications and/or multiple OOAs could be resident on a single device. Additionally, in embodiments of the present invention which have multiple OOAs being executed or resident on a single device, these OOAs may communicate, collaborate and exchange data in a manner similar to that described above.

While one (or more) embodiment(s) of this invention has been illustrated in the accompanying drawings and described above, it will be evident to those skilled in the art that changes and modifications may be made without departing from the invention. All such modifications or variations are believed to be within the scope of the invention as defined by the claims appended hereto.

What is claimed is:

1. A device for communication with intermittent networking comprising:
a communications interface adapted to communicate with a communications network and another device for communication;
an user interface for receiving user inputs;
memory;
a processor in communication with said memory, said communications interface and said user interface, said processor adapting said device to:
track user inputs received through said user interface;
store said tracked user inputs in said memory;
using said communications interface, transmit data corresponding to said tracked user inputs to a synchronizer, said synchronizer being one of said another device communication and a central server.

2. The device for communication of claim I further comprising:
an output device for presenting or rendering of content, said output device in communication with said processor; and
wherein said processor is further adapted to:
prior to tracking said user inputs, retrieve from said memory content for presentation;
using said output device, present a rendering of said retrieved content; and
wherein said user inputs received correspond to a user's interaction with said content rendered.

3. The device for communication of claim I wherein said processor is further adapted to:
receive from said synchronization server additional content;
store in said memory said additional content received; and
present to said user a rendering of said additional content using said output device.

4. The device for communication of claim 3 wherein said additional content received is responsive to said data transmitted to said synchronization server.

5. The device for communication of claim 4 wherein said additional content received is a pointer to content stored on a computing device.

6. The device for communication of claim 1 wherein said processor is further adapted to:
receive from another device for communication data corresponding to tracked user inputs at said another device; and
wherein said synchronization server is a central server.

7. The device for communication of claim 1 wherein said processor is further adapted to:
prior to tracking said user inputs, retrieve tracking instructions for execution by said processor; and
wherein said user inputs are tracked by executing said tracking instructions retrieved.

8. The device for communication of claim 7 wherein said tracking instructions comprise an online-offline agent.

9. The device for communication of claim 7 where in said processor is further adapted to:
transfer to said another device for communication said tracking instructions after completion of tracking said user inputs.

10. The device for communication of claim 9 wherein said processor is further adapted to:
transmit at least a portion of said content retrieved said to another device for communication.

11. The device for communication of claim 2 wherein said processor is further adapted to:
prior to retrieving, receive said content from said another device for communication; and
store said content retrieved in said memory.

12. A computer readable media containing computer instructions, said instructions adapting a network enabled computing device to:
while offline, track a user's interactions with content;
while offline, store said tracked interactions in memory; and
while online, transmit data corresponding to said user interactions to at least one of a synchronization server and another network enabled computing device.

13. The computer readable media of claim 12 further adapting said network enabled computing device to:
while online, communicate with other network enabled computing devices;
while online, receive content from another network enabled computing device; and
store said content received in said memory.

14. The computer readable media of claim 12 further adapting said network enabled computing device to:
prior to tracking user interactions and while online, receive from another network enabled computing device tracking instructions for tracking user interactions; and
execute said tracking instructions.

15. The computer readable media of claim 12 wherein said instructions for tracking user interactions received are configured for at least one of said content received, said output device for rendering content and said network enabled computing device.

16. The computer readable media of claim 12 further adapting said network enabled computing device to:
prior to tracking said user interactions, communicate with another network enabled computing device and retrieve said content; and
during said user interactions with said content, discontinue communication with other network enabled computing devices.

17. A method for communication with intermittent networking, said method comprising:
while online, receiving instructions for tracking interactions with content;
while offline, tracking user interactions with said content presented to a user; and
while online, transmitting to at least one of a synchronization server and another network enabled computing device data corresponding to said tracked user interactions.

18. The method of communication of claim 17 further comprising:
while online, receiving further content from at least one of said synchronization server and said another network enabled computing device responsive to said transmitted data.

19. The method of claim 18 further comprising:
prior to tracking said user interactions:
retrieving said content for presentation to said user; and
wherein said instructions retrieved are dependent upon said content retrieved.

20. The method of claim 19 further comprising:
commencing communication with a computing device; and
transferring to said computing device said instructions retrieved.

21. The method of claim 20 further comprising:
transmitting to said computing device a portion of said content retrieved.
